(19) United States
(12) Patent Application Publication
(10) Pub. No.: US 2013/0213249 A1
(43) Pub. Date: Aug. 22, 2013

(54) FLEXOGRAPHIC PRINTING PLATE PRECURSOR FOR LASER ENGRAVING AND PROCESS FOR PRODUCING SAME, AND FLEXOGRAPHIC PRINTING PLATE AND PROCESS FOR MAKING SAME

(71) Applicant: FUJIFILM CORPORATION, (US)

(72) Inventor: Hisao YAMAMOTO, Haibara-gun (JP)

(73) Assignee: FUJIFILM CORPORATION, Tokyo (JP)

(21) Appl. No.: 13/767,436

(22) Filed: Feb. 14, 2013

(30) Foreign Application Priority Data
Feb. 21, 2012 (JP) 2012-035396

(51) Int. Cl. C08L 75/04

(52) U.S. Cl. CPC C08L 75/04
USPC 101/395; 525/123; 525/206; 525/56; 525/228; 524/503; 524/507; 524/523; 427/144; 264/400

(57) ABSTRACT

A flexographic printing plate precursor for laser engraving that comprises a relief-forming layer formed from a resin composition for laser engraving, wherein the flexographic printing plate precursor for laser engraving has matting agent particles at the surface of the relief-forming layer, and the matting agent particles comprise a water-soluble resin and have a number average particle size of 2 μm to 40 μm.

### TECHNICAL FIELD

The present invention relates to a flexographic printing plate precursor for laser engraving and a process for producing the same, and a flexographic printing plate and a process for making the same.

### BACKGROUND ART

Conventional technologies that are known to improve anti-tackiness (stickiness suppressibility) of a printing plate surface in a flexographic printing plate precursor for laser engraving, include a method of incorporating oil-absorbent inorganic porous fine particles (silica or the like) into a photosensitive resin composition, and adsorbing any tacky adhesive materials (engraving residue) generated at the time of laser engraving (Japanese Patent No. 4024136); and a method of lowering the surface energy by a method of adding a silicone oil or an organic fluorine compound to a printing plate (an external addition method of adding the compound to the plate surface, or an internal addition method of adding the compound to the interior of layers that constitute the plate) (JP-A-2011-062904 (JP-A denotes a Japanese unexamined patent application publication) and Japanese Patent No. 4475505).

### DISCLOSURE OF THE PRESENT INVENTION

### Problems that the Present Invention is to Solve

An object of the present invention is to provide a flexographic printing plate precursor for laser engraving which exhibits less detachment of a matting agent and has excellent plate anti-tackiness, a process for producing the same, a process for making a flexographic printing plate using the printing plate precursor, and a flexographic printing plate obtained by the process.

### Means for Solving the Problems

The above object of the present invention has been achieved by the means described in the following <1>, <11>, <12> and <14>. Preferable embodiments <2> to <10> and <13> will also be described below.

<1> A flexographic printing plate precursor for laser engraving comprising a relief-forming layer formed from a resin composition for laser engraving, wherein the flexographic printing plate precursor for laser engraving has matting agent particles at the surface of the relief-forming layer, and the matting agent particles comprise a water-soluble resin and have a number average particle size of 2 μm to 40 μm.

<2> The flexographic printing plate precursor for laser engraving according to <1>, wherein the water-soluble resin is a copolymer containing a monomer unit having an acidic group.

<3> The flexographic printing plate precursor for laser engraving according to <1> or <2>, wherein the water-soluble resin is a copolymer containing (a) a monomer unit derived from at least one monomer selected from the group consisting of alkyl acrylates with an alkyl residue having 2 to 10 carbon atoms and alkyl methacrylates with an alkyl residue having 4 to 10 carbon atoms.

<4> The flexographic printing plate precursor for laser engraving according to any one of <1> to <3>, wherein the water-soluble resin is a copolymer containing (b) a monomer unit derived from at least one monomer selected from the group consisting of a styrene compound, an acrylonitrile compound, methyl methacrylate and ethyl methacrylate.

<5> The flexographic printing plate precursor for laser engraving according to <2>, wherein the copolymer containing a monomer unit having an acidic group is a copolymer containing (c) a monomer unit derived from at least one monomer selected from the group consisting of acrylic acid, methacrylic acid, maleic acid, itaconic acid, and alkali metal salts and ammonium salts of these acids.

<6> The flexographic printing plate precursor for laser engraving according to any one of <1> to <5>, wherein the water-soluble resin is a resin comprising 10 mass % to 70 mass % of the (a) monomer unit derived from at least one monomer selected from the group consisting of alkyl acrylates with an alkyl residue having 2 to 10 carbon atoms and alkyl methacrylates with an alkyl residue having 4 to 10 carbon atoms; 20 mass % to 80 mass % of the (b) monomer unit derived from at least one monomer selected from the group consisting of a styrene compound, an acrylonitrile compound, methyl methacrylate and ethyl methacrylate; and 6 mass % to 50 mass % of the (c) monomer unit derived from at least one monomer selected from the group consisting of acrylic acid, methacrylic acid, maleic acid, itaconic acid, and alkali metal salts and ammonium salts of these acids.

<7> The flexographic printing plate precursor for laser engraving according to any one of <1> to <6>, wherein the resin composition for laser engraving comprises a polyurethane resin.

<8> The flexographic printing plate precursor for laser engraving according to any one of <1> to <7>, wherein the resin composition for laser engraving further comprises a filler.

<9> The flexographic printing plate precursor for laser engraving according to <8>, wherein the filler in the resin composition for laser engraving is carbon black.

<10> The flexographic printing plate precursor for laser engraving according to any one of <1> to <9>, wherein the flexographic printing plate precursor for laser engraving have a crosslinked relief-forming layer which is produced by thermally crosslinking a relief-forming layer comprising the resin composition for laser engraving.

<11> A process for producing the flexographic printing plate precursor for laser engraving according to any one of <1> to <10>, the process comprising:

a layer forming step of forming a relief-forming layer comprising a resin composition for laser engraving;

a crosslinking step of thermally crosslinking the relief-forming layer to obtain a crosslinked relief-forming layer; and

a matting agent forming step of forming the matting agent particles at the surface of the relief-forming layer or the crosslinked relief-forming layer.

<12> A process for making a flexographic printing plate, the process comprising:

an engraving step of laser-engraving the crosslinked relief-forming layer of the flexographic printing plate precursor for laser engraving according to <10> to form a relief layer.

<13> The process for making a flexographic printing plate according to <12>, wherein the process further comprises a rinsing step of rinsing the surface of the relief layer with water or a liquid containing water as a main component, after the engraving step.

<14> A flexographic printing plate made by the process for making a flexographic printing plate according to <12> or <13>.

### MODE FOR CARRYING OUT THE PRESENT INVENTION

In the present invention, the notation ‘lower limit to upper limit’, which expresses a numerical range, means ‘at least the lower limit but no greater than the upper limit’, and the notation ‘upper limit to lower limit’ means ‘no greater than the upper limit but at least the lower limit’. That is, they are numerical ranges that include the upper limit and the lower limit.

Furthermore, ‘(a) a monomer unit derived from at least one monomer selected from the group consisting of alkyl acrylates with an alkyl residue having 2 to 10 carbon atoms and alkyl methacrylates with an alkyl residue having 4 to 10 carbon atoms’ etc. are also simply called ‘monomer unit (a)’ etc.

Furthermore, in the present invention, ‘mass %’ is used for the same meaning as ‘weight %’, and ‘parts by mass’ is used for the same meaning as ‘parts by weight’.

In the present invention, ‘(meth)acrylate’ means any one or both of ‘acrylate’ and ‘methacrylate’.

Hereinafter, the present invention will be described in detail.

### (Flexographic Printing Plate Precursor for Laser Engraving)

The flexographic printing plate precursor for laser engraving (hereinafter, also simply referred to as ‘flexographic printing plate precursor’) of the present invention comprises a relief-forming layer formed from a resin composition for laser engraving, wherein the flexographic printing plate precursor for laser engraving has matting agent particles at the surface of the relief-forming layer, and the matting agent particles comprise a water-soluble resin and have a number average particle size of 2 μm to 40 μm.

The flexographic printing plate precursor for laser engraving of the present invention preferably has a relief-forming layer on a support.

The first embodiment of the flexographic printing plate precursor for laser engraving of the present invention has matting agent particles at the surface of a relief-forming layer comprising a resin composition for laser engraving.

Furthermore, the second embodiment of the flexographic printing plate precursor for laser engraving of the present invention has matting agent particles at the surface of a crosslinked relief-forming layer which is formed by crosslinking a relief-forming layer comprising a resin composition for laser engraving.

In the present invention, the ‘flexographic printing plate precursor for laser engraving’ means both or any one of a relief printing plate precursor having a crosslinkable relief-forming layer comprising a resin composition for laser engraving in a state before being crosslinked, and a flexographic printing plate precursor having the crosslinkable relief-forming layer in a state in which it is cured by crosslinking.

In the present invention, the ‘relief-forming layer’ means a layer in a state before being crosslinked, that is, a layer formed from the resin composition for laser engraving of the present invention, which may be dried as necessary.

In the present invention, the ‘crosslinked relief-forming layer’ means a layer formed by crosslinking the aforementioned relief-forming layer. The crosslinking is preferably carried out by means of heat. Moreover, the crosslinking is not particularly limited as long as it is a reaction by which the resin composition for laser engraving is cured.

The ‘flexographic printing plate’ is prepared by laser engraving the printing plate precursor having the crosslinked relief-forming layer.

Also, in the present invention, the ‘relief layer’ means a laser-engraved layer in the flexographic printing plate, that is, the crosslinked relief-forming layer obtainable after laser engraving.

### <Matting Agent Particles>

The flexographic printing plate precursor for laser engraving of the present invention has matting agent particles at the surface of a relief-forming layer or a crosslinked relief-forming layer (hereinafter, also simply called ‘the surface of a relief-forming layer’).

In the present invention, the matting agent comprises a water-soluble resin, and the number average particle size thereof is 2 μm to 40 μm. In the present invention, the water-soluble resin is preferably an alkali-soluble resin, and the matting agent preferably comprises an alkali-soluble resin and is more preferably consists of an alkali-soluble resin.

In the present invention, the matting agent particles are preferably particles that form a pattern of discontinuous protrusions at the surface of the relief-forming layer. Furthermore, the matting agent particles preferably comprise an alkali-soluble resin, and the monomer unit that constitutes the alkali-soluble resin can be selected as necessary.

In the present invention, the matting agent particles are preferably fixed to the surface of the relief-forming layer. The state in which the matting agent is fixed to the surface is preferably a state in which the matting agent particles are not completely embedded in the relief-forming layer but are protruded from the surface of the relief-forming layer. The height of the matting agent particles protruded from the surface of the relief-forming layer is preferably 1 μm to 20 μm, and more preferably 3 μm to 10 μm. Furthermore, the number average particle size (width) of the matting agent particles is 2 μm to 40 μm, preferably 3 μm to 30 μm, and more preferably 5 μm to 20 μm.

The number average particle size of the matting agent particles is a value obtained by averaging the diameters (widths) of 100 matting agent particles that are observed from, for example, a digital microscopic magnified photograph of a matting agent fixed to the surface of the relief-forming layer. Also, the height of the matting agent is a value obtained by measuring the differences between the surface of the relief-forming layer and the top of the matting agent (height) by using, for example, a surface roughness analyzer manufactured by Tokyo Seimitsu Co., Ltd., and averaging the differences.

When the number average particle size is in the numerical range described above, a flexographic printing plate precursor having excellent anti-tackiness can be obtained, and thus it is preferable.

In the present invention, the shape of the matting agent particles is not particularly limited, and the matting agent particles may have any arbitrary shape such as a spherical shape, a disc shape, a cubic shape and an indeterminate shape, or various shapes may be combined. The distribution of the particle size may be monodisperse or polydisperse.

The number of the matting agent particles that are formed at the surface of the relief-forming layer is preferably 1 to 1,000 particles/mm², and more preferably 5 to 500 particles/mm². The number of the matting agent particles that are formed at the surface of the relief-forming layer can be regulated by spraying in the matting agent forming step that will be described below. When the number of the matting agent particles is in the numerical range described above, a flexographic printing plate precursor having excellent anti-tackiness can be obtained, and thus it is preferable.

### Water-Soluble Resin

Next, the water-soluble resin which composes the matting agent will be described.

In the present invention, the water-soluble resin is a resin having a water-soluble group. Since the water-soluble resin has a water-soluble group, the water-soluble resin can be dissolved in an aqueous solution at any pH. There are no particular limitations on the water-soluble group, and examples thereof include a carboxyl (carboxy) group, a sulfonic acid group, a phosphonic acid group, a phenolic hydroxyl (hydroxy) group, an amino group, a substituted amino group and an ammonium group.

In the present invention, the water-soluble resin is preferably a copolymer containing a monomer unit having an acidic group. The acidic group is not particularly limited, and preferred examples thereof include a carboxyl group, a sulfonic acid group, a phosphonic acid group and a phenolic hydroxyl group. Among them, a carboxyl group is particularly preferred. It is preferable that the water-soluble resin that is used in the present invention be an alkali-soluble resin by reason of having the acidic group.

The water-soluble resin used in the present invention preferably dissolves in an aqueous alkali solution at pH 11 to 14, and more preferably dissolves in an aqueous alkali solution at pH 10 to 14. It is preferable that the water-soluble resin used in the present invention dissolve in a rinsing liquid within the time of a rinsing step in the process for making a flexographic printing plate of the present invention at room temperature.

The water-soluble resin used in the present invention is preferably an acrylic polymer.

The acrylic polymer in the present invention is an addition polymerization type resin, and is a polymer containing a monomer unit derived from (meth)acrylic acid or an ester thereof. The acrylic polymer may also have a monomer unit other than the monomer unit derived from (meth)acrylic acid or an ester thereof, for example, a monomer unit derived from a styrene compound, a monomer unit derived from an acrylonitrile compound, or a monomer unit derived from a vinyl compound. Furthermore, it is preferable that the alkali-soluble resin used in the present invention contain a monomer unit derived from (meth)acrylic acid and a monomer unit derived from another unsaturated carboxylic acid as the alkali-soluble groups.

Meanwhile, in the present specification, the ‘monomer unit derived from (meth)acrylic acid or an ester thereof is also called an ‘acrylic monomer unit’. Also, (meth)acrylic acid refers to any one or both of methacrylic acid and acrylic acid.

The alkali-soluble resin used in the present invention is preferably a copolymer containing a monomer unit (a), a monomer unit (b), and a monomer unit (c) described below.

The water-soluble resin used in the present invention is preferably a copolymer containing (a) a monomer unit derived from at least one monomer selected from the group consisting of alkyl acrylates with an alkyl residue having 2 to 10 carbon atoms and alkyl methacrylates with an alkyl residue having 4 to 10 carbon atoms. The above-mentioned embodiment is more excellent in adhesiveness to the surface of the relief-forming layer.

Furthermore, the water-soluble resin used in the present invention is preferably a copolymer containing (b) a monomer unit derived from at least one monomer selected from the group consisting of a styrene compound, an acrylonitrile compound, methyl methacrylate and ethyl methacrylate. The above-mentioned embodiment is more excellent in resistance to pressure.

Furthermore, the water-soluble resin used in the present invention is preferably a copolymer containing, as the monomer unit having an acidic group, (c) a monomer unit derived from at least one monomer selected from the group consisting of acrylic acid, methacrylic acid, maleic acid, itaconic acid, and alkali metal salts and ammonium salts thereof. In the above-mentioned embodiment, the solubility of the water-soluble resin in an aqueous alkali solution has further enhanced.

Moreover, the water-soluble resin used in the present invention is preferably a copolymer containing monomer unit (a), monomer unit (b) and monomer unit (c) (hereinafter, also called a specific copolymer).

Monomer unit (a) is preferably a component which imparts adhesiveness to the surface of the relief-forming layer. Specific examples of the monomer from which monomer unit (a) is derived include ethyl acrylate, n-propyl acrylate, isopropyl acrylate, n-butyl acrylate, isobutyl acrylate, n-amyl acrylate, isoamyl acrylate, n-hexyl acrylate, 2-ethylhexyl acrylate, n-octyl acrylate, n-decyl acrylate, n-butyl methacrylate, isobutyl methacrylate, n-amyl methacrylate, 2-ethylhexyl methacrylate, n-octyl methacrylate and n-decyl methacrylate.

Monomer unit (b) is preferably a component which imparts resistance to pressure. Specific examples of the monomer from which monomer unit (b) is derived include styrene, o-methylstyrene, m-methylstyrene, p-methylstyrene, 2,4-dimethylstyrene, 2,5-dimethylstyrene, 3,4-dimethylstyrene, 3,5-dimethylstyrene, 2,4,5-trimethylstyrene, 2,4,6-trimethylstyrene, o-ethylstyrene, m-ethylstyrene, p-ethylstyrene, 3,5-diethylstyrene, 2,4,5-triethylstyrene, p-n-butylstyrene, m-sec-butylstyrene, m-tert-butylstyrene, p-hexylstyrene, p-n-heptylstyrene, p-2-ethylhexylstyrene, o-fluorostyrene, m-fluorostyrene, p-fluorostyrene, o-chlorostyrene, m-chlorostyrene, p-chlorostyrene, 2,3-dichlorostyrene, 2,4-dichlorostyrene, 2,5-dichlorostyrene, 2,6-dichlorostyrene, 3,4-dichlorostyrene, 3,5-dichlorostyrene, 2,3,4,5,6-pentachlorostyrene, m-trifluoromethylstyrene, o-cyanostyrene, m-cyanostyrene, m-nitrostyrene, p-nitrostyrene, o-dimethylaminostyrene, acrylonitrile, α-chloroacrylonitrile, α-bromoacrylonitrile, α-trifluoromethylacrylonitrile, α-trifluoromethylcarboxyacrylonitrile, methyl methacrylate and ethyl methacrylate.

Monomer unit (c) is preferably a component which enhances the solubility in an aqueous alkali solution. Specific examples of the monomer from which monomer unit (c) is derived include acrylic acid, sodium acrylate, potassium acrylate, ammonium acrylate, methacrylic acid, sodium methacrylate, potassium methacrylate, ammonium methacrylate, maleic acid, sodium maleate, potassium maleate, ammonium maleate, itaconic acid, sodium itaconate, potassium itaconate and ammonium itaconate.

In the copolymer containing monomer unit (a), monomer unit (b) and monomer unit (c) described above (specific copolymer), the contents of monomer units (a), (b) and (c) are preferably 10 mass % to 70 mass %, 20 mass % to 80 mass % and 6 mass % to 50 mass %, respectively, and more preferably 15 mass % to 50 mass %, 40 mass % to 70 mass % and 10 mass % to 25 mass %, respectively. The sum of the contents of monomer unit (a), monomer unit (b) and monomer unit (c) is 100 mass % or less.

When the contents of monomer units (a), (b) and (c) in the specific copolymer are in the numerical ranges described above, a specific copolymer which has satisfactory adhesiveness to the surface of the relief-forming layer due to monomer unit (a), satisfactory pressure resistance due to monomer unit (b) and satisfactory solubility in an aqueous alkali solution due to monomer unit (c) may be obtained, and therefore, it is preferable.

The specific copolymer used in the present invention is preferably used as an aqueous solution or an aqueous dispersion. An aqueous solution of the specific copolymer can be obtained by, for example in monomer unit (c), converting a portion of the monomer unit derived from acrylic acid or methacrylic acid to a sodium salt, a potassium salt, or an ammonium salt, and dissolving the salt in water or an aqueous alkali solution. Furthermore, the aqueous dispersion of the specific copolymer used in the present invention can be obtained by, for example, carrying out the process for synthesizing the specific copolymer in the same manner as the conventionally known latex synthesis method. That is, the aqueous dispersion of the specific copolymer can be obtained by dispersing a raw material monomer in water by using a surfactant and emulsion polymerizing the monomer by using a polymerization initiator such as potassium persulfate.

In the process for producing a flexographic printing plate precursor for laser engraving of the present invention, the matting agent particles used in the present invention are preferably formed at the surface of the relief-forming layer or the crosslinked relief-forming layer by a matting agent forming step in which an aqueous solution or aqueous dispersion of the alkali-soluble resin used in the present invention is sprayed and dried. The matting agent forming step will be described in detail below.

### <Relief-Forming Layer>

The relief-forming layer used in the present invention is a layer formed by a resin composition for laser engraving comprising a binder polymer that will be described below, and is preferably a thermally crosslinkable layer.

The preferred embodiment of making a flexographic printing plate by using the flexographic printing plate precursor for laser engraving of the present invention is an embodiment of producing a flexographic printing plate by crosslinking the relief-forming layer to obtain a flexographic printing plate precursor having a crosslinked relief-forming layer, and then laser-engraving the crosslinked relief-forming layer (hard relief-forming layer) to form a relief layer. By crosslinking the relief-forming layer, abrasion of the relief layer at the time of printing can be prevented, and also, a flexographic printing plate having a relief layer with a sharp shape after being laser-engraved can be obtained. The flexographic printing plate precursor for laser engraving of the present invention has matting agent particles at the surface of the relief-forming layer or the crosslinked relief-forming layer.

In the present invention, the relief-forming layer may be formed by molding the resin composition for laser engraving that has the above-mentioned components for a relief-forming layer into a sheet shape or a sleeve shape. The relief-forming layer is usually provided above a support, which is described later, but it may be formed directly on the surface of a member such as a cylinder of equipment for plate making or printing or may be placed and immobilized thereon, and a support is not always required.

The thickness of the relief-forming layer in the flexographic printing plate precursor for laser engraving before and after crosslinking is preferably at least 0.05 mm but no greater than 10 mm, more preferably at least 0.05 mm but no greater than 7 mm, and yet more preferably at least 0.05 mm but no greater than 3 mm.

The flexographic printing plate precursor for laser engraving has matting agent particles on the surface of the relief-forming layer, and may further comprise, as necessary, an adhesive layer between the support and the relief-forming layer and, above the relief-forming layer, a slip coat layer and a protection film.

### <Support>

A material used for the support of the relief printing plate precursor for laser engraving of the present invention is not particularly limited, but one having high dimensional stability is preferably used, and examples thereof include metals such as steel, stainless steel, or aluminum, plastic resins such as a polyester (e.g. PET (polyethylene terephthalate), PBT (polybutylene terephthalate), or PAN (polyacrylonitrile)) or polyvinyl chloride, synthetic rubbers such as styrene-butadiene rubber, and glass fiber-reinforced plastic resins (epoxy resin, phenolic resin, etc.). As the support, a PET film or a steel substrate is preferably used. The configuration of the support depends on whether the relief-forming layer is in a sheet shape or a sleeve shape.

### <Adhesive Layer>

An adhesive layer may be provided between the relief-forming layer and the support for the purpose of strengthening the adhesion between the two layers.

Examples of materials (adhesives) that can be used in the adhesive layer include those described in ‘Handbook of Adhesives’, Second Edition, Ed by I. Skeist, (1977).

### <Resin Composition for Laser Engraving>

In the flexographic printing plate precursor for laser engraving of the present invention, the relief-forming layer preferably comprises a thermally crosslinkable resin composition for laser engraving (hereinafter, also simply referred to as a ‘resin composition’). The thermally crosslinkable resin composition preferably comprises a binder polymer, a crosslinking agent and a filler. Furthermore, the thermally crosslinkable resin composition preferably comprises an arbitrary additive such as a polymerization initiator or a crosslinking promoting agent, if necessary.

The resin composition for laser engraving of the present invention may widely be applied to other applications without particular limitations, in addition to the application of the relief-forming layer of a flexographic printing plate precursor to be subjected to laser engraving. For example, it may be applied not only to the relief-forming layer of a printing plate precursor that is subjected to raised relief formation by laser engraving, which will be described in detail below, but also to the formation of other products in which asperities or openings are formed on the surface, for example, various printing plates and various formed bodies in which images are formed by laser engraving such as an intaglio plate, a stencil plate and a stamp.

Among them, a preferred embodiment is use in formation of a relief-forming layer provided above an appropriate support.

### Binder Polymer

The resin composition for laser engraving that is used in the present invention preferably comprises a binder polymer.

The binder polymer is preferably a binding resin having a weight average molecular weight of 1,000 to 3,000,000 (hereinafter, also referred to as ‘binder’). In the present invention, one kind of a binder may be used alone, or two or more kinds of binders may be used together. Particularly, when the resin composition for laser engraving is used in the relief-forming layer of the printing plate precursor, it is preferable to select the binder by considering various performances such as laser engraving sensitivity, ink receptivity, and engraving residue dispersibility.

In the present invention, the weight average molecular weight of the binder polymer is preferably 1,000 to 3,000,000, more preferably 2,000 to 500,000, even more preferably 3,000 to 100,000, and particularly preferably 5,000 to 50,000.

The weight average molecular weight can be measured by using a GPC (gel permeation chromatography) method and can be determined by using a calibration curve of standard polystyrene. Here, the weight average molecular weight is a value in terms of polystyrene in GPC measurement.

In the present invention, examples of the binder polymer include a polystyrene resin, a polyester resin, a polyamide resin, a polyurea resin, a polyamideimide resin, a polyurethane resin, a polysulfone resin, a polyether sulfone resin, a polyimide resin, a polycarbonate resin, a hydrophilic polymer containing a hydroxyethylene unit, an acrylic resin, an acetal resin, an epoxy resin, a polycarbonate resin, a rubber and a thermoplastic elastomer. Among them, particularly preferred examples include a polyurethane resin and an acetal resin.

The polyurethane resin and the acetal resin will be described below.

### Polyurethane Resin

The resin composition for laser engraving that is used in the present invention more preferably comprises a polyurethane resin as a binder polymer.

The polyurethane resin is preferably a resin having a urethane bond which is a reaction product of at least one diol compound represented by following formula (1) and at least one diisocyanate compound represented by following formula (2). In order to obtain the polyurethane resin, a synthesis method based on a known polyaddition reaction can be used. For example, the synthesis method described in Examples 1 to 7 of JP-A-2011-136430 may be used.

HO—X⁰—OH (1)

OCN—Y⁰—NCO (2)

In formula (1) and formula (2), X⁰ and Y⁰ independently represent a divalent organic group.

The diol compound and the diisocyanate compound will be described below.

### —Diol Compound—

In the present invention, preferred examples of the diol compound include the straight-chain aliphatic diols, branched aliphatic diols, and cyclic aliphatic diols below.

Examples of the straight-chain aliphatic diol include a straight-chain aliphatic diol having 3 to 50 carbons such as 1,3-propanediol, 1,4-butanediol, 1,5-pentanediol, 1,6-hexanediol, 1,7-heptanediol, 1,8-octanediol, 1,9-nonanediol, 1,10-decanediol, 1,12-dodecanediol, 1,16-hexadecanediol, or 1,20-eicosanediol.

Examples of the branched aliphatic diol include a branched aliphatic diol having 3 to 30 carbons such as 2-methyl-1,3-propanediol, 2-ethyl-1,3-propanediol, neopentyl glycol, 2,2-diethyl-1,3-propanediol, 2-methyl-2-propyl-1,3-propanediol, 2-butyl-2-ethyl-1,3-propanediol, 2,2-dibutyl-1,3-propanediol, 1,2-butanediol, 2-ethyl-1,4-butanediol, 2-isopropyl-1,4-butanediol, 2,3-dimethyl-1,4-butanediol, 2,3-diethyl-1,4-butanediol, 3,3-dimethyl-1,2-butanediol, pinacol, 1,2-pentanediol, 1,3-pentanediol, 2,3-pentanediol, 2-methyl-2,4-pentanediol, 3-methyl-1,5-pentanediol, 2-ethyl-1,5-pentanediol, 3-ethyl-1,5-pentanediol, 2-isopropyl-1,5-pentanediol, 3-isopropyl-1,5-pentanediol, 2,4-dimethyl-1,5-pentanediol, 2,4-diethyl-1,5-pentanediol, 2,3-dimethyl-1,5-pentanediol, 2,2,3-trimethyl-1,3-pentanediol, 1,2-hexanediol, 1,3-hexanediol, 1,4-hexanediol, 2,5-hexanediol, 2-ethyl-1,6-hexanediol, 2-ethyl-1,3-hexanediol, 2-isopropyl-1,6-hexanediol, 2,4-diethyl-1,6-hexanediol, 2,5-dimethyl-2,5-hexanediol, 2-methyl-1,8-octanediol, 2-ethyl-1,8-octanediol, 2,6-dimethyl-1,8-octanediol, 1,2-decanediol, or 8,13-dimethyl-1,20-eicosanediol.

Examples of the cyclic aliphatic diol include a cyclic aliphatic diol having 3 to 30 carbons such as 1,2-cyclohexanediol, 1,3-cyclohexanediol, 1,4-cyclohexanediol, 1,2-cyclohexanedimethanol, 1,3-cyclohexanedimethanol, 1,4-cyclohexanedimethanol, m-xylene-α,α′-diol, p-xylene-α,α′-diol, 2,2-bis(4-hydroxycyclohexyl)propane, 2,2-bis(4-hydroxyphenyl)propane, or dimer diol.

Among them, the diol compound is preferably a polycarbonate diol represented by Formula (1) below.

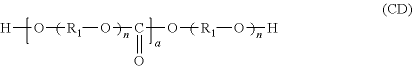

In formula (CD), R₁'s independently represent a linear, branched and/or cyclic divalent hydrocarbon group having 2 to 50 carbon atoms, which may contain an oxygen atom or the like (at least one atom selected from the group consisting of a nitrogen atom, a sulfur atom and an oxygen atom) in the carbon skeleton; R₁'s may be a single component or may be composed of plural components; n is preferably an integer from 1 to 500; and a is preferably an integer of 1 or greater.

Among them, R₁ is preferably a divalent alkylene group having 2 to 6 carbon atoms, and more preferably a dimethylene group, a trimethylene group, a tetramethylene group or a hexamethylene group. n is preferably an integer from 1 to 5.

The ‘hydrocarbon group’ in R₁ is a saturated or unsaturated hydrocarbon group.

The ‘carbon skeleton’ in R₁ means a structural part having 3 to 50 carbons forming the hydrocarbon group, and the term ‘which may contain an oxygen atom, etc. in a carbon skeleton’ means a structure in which an oxygen atom, etc. is inserted into a carbon-carbon bond of a main chain or a side chain. Furthermore, it may be a substituent having an oxygen atom, etc., bonded to a carbon atom in a main chain or a side chain.

R₁ in the polycarbonate diol is preferably introduced from a diol compound preferably used as a starting material for synthesis of the polycarbonate diol.

Preferred examples of the diol compound include the above-mentioned straight-chain aliphatic diols, branched aliphatic diols, and cyclic aliphatic diols.

Examples of the polyhydric alcohol that is preferably used in order to introduce a hydrocarbon group containing at least one type of atom selected from the group consisting of nitrogen, sulfur, and oxygen in R₁ include diethylene glycol, triethylene glycol, tetraethylene glycol, glycerol, 1,2,6-hexanetriol, trimethylolethane, trimethylolpropane, pentaerythritol, dihydroxyacetone, 1,4:3,6-dianhydroglucitol, diethanolamine, N-methyldiethanolamine, dihydroxyethylacetamide, 2,2′-dithiodiethanol, and 2,5-dihydroxy-1,4-dithiane.

With regard to R₁ as a hydrocarbon group having at least one type of atom selected from the group consisting of nitrogen, sulfur, and oxygen, from the viewpoint of solvent resistance R₁ preferably comprises at least one ether bond, and from the viewpoint of solvent resistance and durability R₁ is more preferably a diethylene glycol-derived group (group represented by —(CH₂)₂—O—(CH₂)₂—). Preferred examples of R₁ include a group represented by Formula (CD2) below.

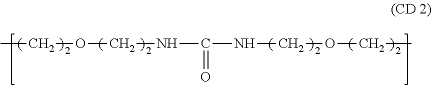

The polycarbonate diol may be produced by for example a conventionally known method as described in JP-B-5-29648 (JP-B denotes a Japanese examined patent application publication), and specifically it may be produced by an ester exchange reaction between a diol and a carbonic acid ester.

Examples of commercially available polycarbonate diols include the product name ‘PLACCEL CD205PL’, the product name ‘PLACCEL CD210PL’, and the product name ‘PLACCEL CD220PL’ (all manufactured by Daicel Chemical Industries, Ltd.), ‘PCDL T5652’ and ‘PCDL L4672’ (both manufactured by Asahi Kasei), and ‘UM-CARB90 (1/1)’ (Ube Industries, Ltd.).

In the present invention, with regard to the polycarbonate diol, one type or two or more types may be used according to the intended purpose, but it is desirable to use one type of polycarbonate diol.

The number-average molecular weight of these polycarbonate diols is preferably in the range of 1,000 to 200,000, more preferably in the range of 1,500 to 10,000, and yet more preferably in the range of 2,000 to 8,000.

A polyurethane resin having a carbonate bond may be obtained by subjecting a hydroxy group of the polycarbonate diol to a polyaddition reaction with an isocyanate group of the diisocyanate compound represented by Formula (2).

### —Diisocyanate Compound—

Next, the diisocyanate compound represented by Formula (2) is explained. In the above-mentioned Formula (2), Y⁰ represents a divalent aliphatic or aromatic hydrocarbon group which may be substituted. According to necessity, Y⁰ may have another functional group which does not react with an isocyanate group, for example, an ester group, a urethane group, an amide group, or an ureido group.

Examples of the diisocyanate compound include an aliphatic diisocyanate compound, an alicyclic diisocyanate compound, an aromatic-aliphatic diisocyanate compound, and an aromatic diisocyanate compound.

Examples of the aliphatic diisocyanate compound include 1,3-trimethylene diisocyanate, 1,4-tetramethylene diisocyanate, 1,3-pentamethylene diisocyanate, 1,5-pentamethylene diisocyanate, 1,6-hexamethylene diisocyanate, 1,2-propylene diisocyanate, 1,2-butylene diisocyanate, 2,3-butylene diisocyanate, 1,3-butylene diisocyanate, 2-methyl-1,5-pentamethylene diisocyanate, 3-methyl-1,5-pentamethylene diisocyanate, 2,4,4-trimethyl-1,6-hexamethylene diisocyanate, 2,2,4-trimethyl-1,6-hexamethylene diisocyanate, 2,6-diisocyanate methyl caproate, and lysine diisocyanate.

Examples of the alicyclic diisocyanate compound include 1,3-cyclopentane diisocyanate, 1,4-cyclohexane diisocyanate, 1,3-cyclohexane diisocyanate, 3-isocyanatomethyl-3,5,5-trimethylcyclohexyl isocyanate, 4,4′-methylenebis(cyclohexyl isocyanate), methyl-2,4-cyclohexane diisocyanate, methyl-2,6-cyclohexane diisocyanate, 1,3-bis(isocyanatomethyl)cyclohexane, 1,4-bis(isocyanatomethyl)cyclohexane, isophorone diisocyaante, and norbornane diisocyanate.

Examples of the aromatic-aliphatic diisocyanate compound include 1,3-xylene diisocyanate, 1,4-xylene diisocyanate, ω,ω′-diisocyanato-1,4-diethylbenzene, 1,3-bis(1-isocyanato-1-methylethyl)benzene, 1,4-bis(1-isocyanato-1-methylethyl)benzene, and 1,3-bis(α,α-dimethylisocyanatomethyl)benzene.

Examples of the aromatic diisocyanate compound include m-phenylene diisocyanate, p-phenylene diisocyanate, 2,4-tolylene diisocyanate, 2,6-tolylene diisocyanate, naphthylene-1,4-diisocyanate, 1,5-naphthalene diisocyanate, 4,4′-diphenyl diisocyanate, 4,4′-diphenylmethane diisocyanate, 2,4′-diphenylmethane diisocyanate, 4,4′-diphenyl ether diisocyanate, 2-nitrodiphenyl-4,4′-diisocyanate, 2,2′-diphenylpropane-4,4′-diisocyanate, 3,3′-dimethyldiphenylmethane-4,4′-diisocyanate, 4,4′-diphenylpropane diisocyanate, and 3,3′-dimethoxydiphenyl-4,4′-diisocyanate.

Among them, 1,6-hexamethylene diisocyanate, 1,3-bis(isocyanatomethyl)cyclohexane, isophorone diisocyaante, 4,4′-diphenylmethane diisocyanate, and 2,4-tolylene diisocyanate are more preferable.

The polyurethane resin used in the present invention preferably has an ethylenically unsaturated group at an end or in a side chain of the main polymer chain. The ethylenically unsaturated group at an end of the main chain may be present at one end only, but the polyurethane resin preferably has the ethylenically unsaturated group at both ends of the main chain.

Examples of the ethylenically unsaturated group include a group with an unsaturated carboxylic acid as a starting material, such as an acryloyl group, a methacryloyl group, an acrylamide group, a methacrylamide group, or a phthalimide group, and a radically polymerizable group such as a styryl group, a vinyl group, or an allyl group. Among them, an acryloyl group and a methacryloyl group are preferable.

An ethylenically unsaturated group can be introduced into an end of the main chain of the polyurethane resin by, in the polyaddition reaction used for the synthesis of the polyurethane resin, allowing a hydroxyl group or an isocyanate group to remain at an end of the main chain of the polyurethane resin obtained, and causing the polyurethane resin to react with a compound having a functional group which is reactive with the hydroxyl group or isocyanate group, and an ethylenically unsaturated group. The compound having such functional group is more preferably a compound having an isocyanate group for a terminal hydroxyl group, or a compound having a hydroxyl group for a terminal isocyanate group.

Specific examples of a compound having a functional group which is reactive with a hydroxyl group at an end of the main chain of the polyurethane resin and an ethylenically unsaturated group include, as commercially available products, 2-methacryloyloxyethyl isocyanate (KARENZ MOI (registered trademark)), 2-acryloyloxyethyl isocyanate (KARENZ AOI (registered trademark)) and 1,1-bis(acryloyloxymethyl)ethyl isocyanate (KARENZ BEI (registered trademark)) (all manufactured by Showa Denko K.K.).

Specific examples of a compound having a functional group which is reactive with an isocyanate group at an end of the main chain of the polyurethane resin and an ethylenically unsaturated group include 2-hydroxyethyl acrylate, 2-hydroxyethyl methacrylate, 2-hydroxypropyl acrylate and 2-hydroxypropyl methacrylate.

Examples of a method for introducing an ethylenically unsaturated group into a side chain of the polyurethane resin include a method of using a compound which already has an ethylenically unsaturated group as the diol compound or diisocyanate compound that is used as a raw material, in the polyaddition reaction used for the synthesis of the polyurethane resin. Furthermore, a method in which a polyurethane resin is obtained from a raw material monomer having a reactive group such as a carboxyl group, a hydroxyl group or an amino group, and then a compound having a functional group such as an epoxy group or an isocyanate group which reacts with the reactive group such as a carboxyl group, a hydroxyl group or an amino group carried in a side chain of the polyurethane resin, and an ethylenically unsaturated group, is allowed to react with the polyurethane resin to introduce the ethylenically unsaturated group into the side chain, may also be used.

The polyurethane resin used in the present invention may have, as a functional group, an organic group which contains at least one of an ether bond, an amide bond, a urea bond, an ester bond, a biuret bond and an allophanate bond, in addition to the urethane bond.

### Acetal Resin

The resin composition for laser engraving that is used in the present invention preferably comprises an acetal resin as a binder polymer. The acetal resin is preferably polyvinyl acetal, and derivatives thereof.

In this description, hereinafter, polyvinyl acetal and derivatives thereof are called just a polyvinyl acetal derivative. That is, a polyvinyl acetal derivative includes polyvinyl acetal and derivatives thereof, and is a generic term used to refer to compounds obtained by converting polyvinyl alcohol obtained by saponifying polyvinyl acetate into a cyclic acetal.

The acetal content in the polyvinyl acetal derivative (mole % of vinyl alcohol units converted into acetal relative to the total number of moles of vinyl acetate monomer starting material as 100 mol %) is preferably 30 to 90 mol %, more preferably 50 to 85 mol %, and particularly preferably 55 to 78 mol %.

The vinyl alcohol unit in the polyvinyl acetal is preferably 10 to 70 mol % relative to the total number of moles of the vinyl acetate monomer starting material, more preferably 15 to 50 mol %, and particularly preferably 22 to 45 mol %.

Furthermore, the polyvinyl acetal may have a vinyl acetate unit as another component, and the content thereof is preferably 0.01 to 20 mol %, and more preferably 0.1 to 10 mol %. The polyvinyl acetal derivative may further have another copolymerized constitutional unit.

Examples of the polyvinyl acetal derivative include a polyvinyl butyral derivative, a polyvinyl propylal derivative, a polyvinyl ethylal derivative, and a polyvinyl methylal derivative. Among them, a polyvinyl butyral derivative (hereinafter, it is also referred to as a “PVB derivative”) is a derivative that is preferable. In this description, for examples, a polyvinyl butyral derivative includes polyvinyl butyral and derivatives thereof, and the same can be said for other polyvinyl acetal derivatives.

Hereinafter, polyvinyl butyral and derivatives thereof are cited for explanation as particularly preferable examples of polyvinyl acetal, but are not limited to these.

Polyvinyl butyral has a structure as shown below, and is constituted while including these structural units, and L is preferably 50 mol % and more.

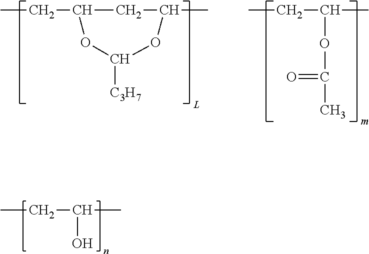

The PVB derivative is also available as a commercial product, and preferred examples thereof include, from the viewpoint of alcohol dissolving capability (particularly, ethanol), “S-REC B” series and “S-REC K (KS)” series manufactured by SEKISUI CHEMICAL CO., LTD. and “DENKA BUTYRAL” manufactured by DENKI KAGAKU KOGYO KABUSHIKI KAISHA. From the viewpoint of alcohol dissolving capability (particularly, ethanol), “S-REC B” series manufactured by SEKISUI CHEMICAL CO., LTD. and “DENKA BUTYRAL” manufactured by DENKI KAGAKU KOGYO KABUSHIKI KAISHA are more preferable. Among these, particularly preferable commercial products are shown below along with the values L, m, and n in the above formulae and the molar weight. Examples of “S-REC B” series manufactured by SEKISUI CHEMICAL CO., LTD. include “BL-1” (L=61, m=3, n=36, weight-average molecular weight: 19,000), “BL-1H” (L=67, m=3, n=30, weight-average molecular weight: 20,000), “BL-2” (L=61, m=3, n=36, weight-average molecular weight: about 27,000), “BL-5” (L=75, m=4, n=21, weight-average molecular weight: 32,000), “BL-S” (L=74, m=4, n=22, weight-average molecular weight: 23,000), “BM-S” (L=73, m=5, n=22, weight-average molecular weight: 53,000), and “BH-S” (L=73, m=5, n=22, weight-average molecular weight: 66,000), examples of “DENKA BUTYRAL” manufactured by DENKI KAGAKU KOGYO include “#3000-1” (L=71, m=1, n=28, weight-average molecular weight: 74,000), “#3000-2” (L=71, m=1, n=28, weight-average molecular weight: 90,000), “#3000-4” (L=71, m=1, n=28, weight-average molecular weight: 117,000), “#4000-2” (L=71, m=1, n=28, weight-average molecular weight: 152,000), “#6000-C” (L=64, m=1, n=35, weight-average molecular weight: 308,000), “#6000-EP” (L=56, m=15, n=29, weight-average molecular weight: 381,000), “#6000-CS” (L=74, m=1, n=25, weight-average molecular weight: 322,000), and “#6000-AS” (L=73, m=1, n=26, weight-average molecular weight: 242,000), and examples of “MOWITAL” manufactured by KURARAY CO., LTD. include “B60H” (L=71, m=1, n=28, weight-average molecular weight: 140,000), “B60HH” (L=80, m=1, n=19, weight-average molecular weight: 190,000), and “B30HH” (L=80, m=1, n=19, weight-average molecular weight: 130,000).

When the relief-forming layer is formed using the PVB derivative, a method of casting and drying a solution in which a solvent is dissolved is preferable from the viewpoint of smoothness of the film surface.

The content of the binder polymer in the resin composition for laser engraving that is used in the present invention is preferably 2 mass % to 95 mass %, and more preferably 30 mass % to 80 mass %, relative to the total mass of the solid content excluding volatile components such as a solvent.

If the content of the binder polymer is within the range described above, the flexographic printing plate precursor obtainable from the resin composition used in the present invention causes less contamination of the process due to detachment of the matting agent, and is excellent in anti-tackiness.

### Crosslinking Agent

The resin composition for laser engraving that can be used in the present invention preferably comprises a crosslinking agent.

In the present invention, from the viewpoint of forming a crosslinked structure in a relief-forming layer, the resin composition for laser engraving preferably comprises a crosslinking agent in order to form the crosslinked structure.

The crosslinking agent that can be used in the present invention is not particularly limited as long as polymerization as a result of a chemical reaction due to light or heat (a radical polymerization reaction or a crosslinking reaction employing an acid/base as an initiating species, etc.) to thus cure a relief-forming layer is possible. In particular, it is preferable to use (1) a compound having an ethylenically unsaturated group (hereinafter, also called a ‘polymerizable compound’), and (2) a crosslinking agent having —SiR¹R²R³ (R¹ to R³ independently denote a hydrogen atom, a halogen atom, or a monovalent organic group, and at least one of R¹ to R³ is an alkyl group, an aryl group, an alkoxy group, a hydroxy group, or a halogen atom).

These compounds may form a crosslinked structure in the relief-forming layer by a reaction with the above-mentioned binder, may form a crosslinked structure by a reaction of these compounds themselves, or may form a crosslinked structure by both of these reactions.

The molecular weight of these crosslinking agents is not particularly limited, but is preferably 50 to 3,000, more preferably 70 to 2,500, and yet more preferably 100 to 2,000.

From the viewpoint of flexibility and brittleness of a crosslinked film, the total content of the crosslinking agent in the resin composition for laser engraving of the present invention is preferably in the range of 10 to 60 mass % relative to nonvolatile components, and more preferably in the range of 15 to 45 mass %.

### —Polymerizable Compound—

The resin composition for laser engraving that can be used in the present invention preferably comprises a polymerizable compound.

The ‘polymerizable compound’ referred to in the present invention means a compound having at least one ethylenically unsaturated group.

The ethylenically unsaturated group is not particularly limited; a (meth)acryloyl group, a vinyl group, an allyl group, etc. are preferably used, and a (meth)acryloyl group is particularly preferably used.

Examples of monofunctional polymerizable compounds include unsaturated carboxylic acids such as acrylic acid, methacrylic acid, itaconic acid, crotonic acid, isocrotonic acid, and maleic acid and salts thereof, an ethylenically unsaturated group-containing anhydride, a (meth)acrylate, a (meth)acrylamide, an acrylonitrile, a styrene, and various types of polymerizable compounds such as an unsaturated polyester resin, an unsaturated polyether resin, an unsaturated polyamide resin, and an unsaturated urethane resin.

Furthermore, preferred examples of the monofunctional polymerizable compound used include (meth)acrylic acid derivatives such as methyl(meth)acrylate, ethyl(meth)acrylate, n-butyl(meth)acrylate, 2-ethylhexyl(meth)acrylate, 2-hydroxyethyl(meth)acrylate, butoxyethyl(meth)acrylate, carbitol (meth)acrylate, cyclohexyl(meth)acrylate, benzyl(meth)acrylate, N-methylol(meth)acrylamide, and epoxy(meth)acrylate, N-vinyl compounds such as N-vinylpyrrolidone and N-vinylcaprolactam, and allyl compounds such as allyl glycidyl ether, diallyl phthalate, and triallyl trimellitate.

Examples of polyfunctional polymerizable compounds include ester or amide compounds of an unsaturated carboxylic acid and a polyhydric alcohol compound or a polyvalent amine compound, such as ethylene glycol di(meth)acrylate, triethylene glycol di(meth)acrylate, propylene glycol di(meth)acrylate, 1,3-butanediol diitaconate, pentaerythritol dicrotonate, sorbitol tetramalate, methylenebis(meth)acrylamide, and 1,6-hexamethylenebis(meth)acrylamide, urethane acrylates described in JP-A-51-37193, polyester acrylates described in JP-A-48-64183, JP-B-49-43191 (JP-B denotes a Japanese examined patent application publication) and JP-B-52-30490, and a polyfunctional acrylate or methacrylate such as an epoxy acrylate formed by reaction of an epoxy resin and (meth)acrylic acid. Furthermore, radically polymerizable or crosslinkable monomers and oligomers that are commercial products or are industrially known, such as those described in Journal of the Adhesion Society of Japan, Vol. 20, No. 7, pp. 300 to 308 (1984); ‘Kakyozai Handobukku’ (Crosslinking Agent Handbook), Ed. S. Yamashita (Taiseisha, 1981); ‘UV•EB Koka Handobukku (Genryohen)’ (UV•EB Curing Handbook (Starting Materials)) Ed. K. Kato (Kobunshi Kankoukai, 1985); ‘UV•EB Koka Gijutsu no Oyo to Shijyo’ (Application and Market of UV•EB Curing Technology), p. 79, Ed. RadTech (CMC, 1989); and E. Takiyama ‘Poriesuteru Jushi Handobukku’ (Polyester Resin Handbook), (The Nikkan Kogyo Shimbun Ltd., 1988) may be used.

In the relief printing plate precursor of the present invention, which is described later, since a preferred mode is one in which there is a crosslinked relief-forming layer having a crosslinked structure in the film, a polyfunctional polymerizable compound is preferably used.

From the viewpoint of flexibility and brittleness of the crosslinked film, the total content of the polymerizable compound in the resin composition for laser engraving of the present invention is preferably in the range of 10 to 60 mass % relative to nonvolatile components, and more preferably in the range of 15 to 45 mass %.

When a polymerizable compound is used as the crosslinking agent, it is preferable to use a polymer having an ethylenically unsaturated group in the molecule as the binder polymer, but another binder polymer may be used.

—Crosslinking agent having —SiR¹R²R³—

As the crosslinking agent that can be used in the present invention, a crosslinking agent having at least —SiR¹R²R³ as a crosslinkable group can preferably be cited, and a crosslinking agent having two or more —SiR¹R²R³ can more preferably be cited.

R¹ to R³ independently denote a hydrogen atom, a halogen atom, or a monovalent organic group. At least one of R¹ to R³ is an alkyl group, an alkoxy group, a hydroxy group, or a halogen atom.

It is preferable that at least two of R¹ to R³ are alkoxy groups or halogen atoms, and it is particularly preferable that R¹ to R³ are independently alkoxy groups or halogen atoms. From the viewpoint of ease of handling a compound it is preferable that at least two of R¹ to R³ are alkoxy groups.

From the viewpoint of rinsing properties and printing durability, the alkoxy group denoted by R′ to R³ above is preferably an alkoxy group having 1 to 30 carbon atoms, more preferably an alkoxy group having 1 to 15 carbon atoms, and yet more preferably an alkoxy group having 1 to 5 carbon atoms.

Furthermore, examples of the halogen atom denoted by R¹ to R³ above include an F atom, a Cl atom, a Br atom, and an I atom; from the viewpoint of ease of synthesis and stability a Cl atom and a Br atom are preferable, and a Cl atom is more preferable.

Among the above, it is preferable that all of R¹ to R³ are methoxy groups or ethoxy groups.

A crosslinking agent having two or more —SiR¹R²R³ is also preferably used. A crosslinking agent having two to six —SiR¹R²R³ is preferably used. As a group that links two or more —SIR¹R²R³ in a crosslinking agent having two or more —SiR¹R²R³, a di- or higher-valent organic group can be cited; from the viewpoint of high engraving sensitivity a heteroatom (N, S, O)-containing di- or higher-valent organic group is preferable, and an S atom-containing di- or higher-valent organic group is more preferable.

As a crosslinking agent having at least —SiR¹R²R³, a compound having in the molecule two groups in which a methoxy group or ethoxy group is bonded to an Si atom and the Si atoms are bonded via an alkylene group containing a heteroatom, and particularly preferably an S atom, is suitable.

Examples of the crosslinking agent having —SiR¹R²R³ include vinyltrichlorosilane, vinyltrimethoxysilane, vinyltriethoxysilane, β-(3,4-epoxycyclohexyl)ethyltrimethoxysilane, γ-glycidoxypropyltrimethoxysilane, γ-glycidoxypropylmethyldiethoxysilane, γ-glycidoxypropyltriethoxysilane, γ-methacryloxypropylmethyldimethoxysilane, γ-methacryloxypropyltrimethoxysilane, γ-methacryloxypropylmethyldiethoxysilane, γ-methacryloxypropyltriethoxysilane, γ-acryloxypropyltrimethoxysilane, N-(β-aminoethyl)-γ-aminopropylmethyldimethoxysilane, N-(β-aminoethyl)-γ-aminopropyltrimethoxysilane, N-(β-aminoethyl)-γ-aminopropyltriethoxysilane, γ-aminopropyltrimethoxysilane, γ-aminopropyltriethoxysilane, N-phenyl-γ-aminopropyltrimethoxysilane, γ-mercaptopropyltrimethoxysilane, γ-chloropropyltrimethoxysilane, and γ-ureidopropyltriethoxysilane.

Specific examples of the crosslinking agent having —SiR¹R²R³ that can be used in the present invention further include the compounds described in paragraphs 0073 to 0084 of JP-A-2011-136455.

In the resin composition for laser engraving that is used in the present invention, the content of the crosslinking agent having —SiR¹R²R³ is preferably within a range of 10 mass % to 60 mass %, and more preferably within a range of 15 mass % to 45 mass %, relative to the total mass of the solid content of the resin composition, from the viewpoint of flexibility and brittleness of the crosslinked film.

When a compound having —SiR¹R²R³ is used as the crosslinking agent, it is preferable to use a binder polymer having a functional group such as a hydroxy group, etc. (the above-mentioned polyvinyl acetal derivative, etc.) that can react therewith, but another binder polymer may be used.

### —Filler—

The resin composition for laser engraving that can be used in the present invention preferably comprises a filler.

The filler in the present invention is not particularly limited, only if it does not molecularly disperses in the resin composition but disperses in a solid state.

Fillers used in the present invention include organic fillers and inorganic fillers, and among them, carbon black is particularly preferable.

Examples of the organic fillers include low density polyethylene particles, high density polyethylene particles, polystyrene particles, various organic pigments, micro balloons, urea-formalin fillers, polyester particles, cellulose fillers, organic metals, etc.

As organic pigments, known ones are cited, including indigo-based pigment, quinacridone-based pigment, dioxazine-based pigment, isoindolinone-based pigment, quinophthalone-based pigment, dyed lake pigment, azine pigment, nitroso pigment, nitro pigment, natural pigment, fluorescent pigment, etc. An inorganic pigment may be contained.

Among them, carbon black is particularly preferable as organic fillers.

As carbon black, only if there is no such problem as dispersion instability in the resin composition constituting the relief-forming layer, any of carbon blacks usually used for various applications such as coloring, rubber and dry battery is used, in addition to products falling within standards classified by ASTM.

The carbon black cited here also includes, for example, furnace black, thermal black, channel black, lampblack, acetylene black, etc.

In the present invention, it is also possible to use carbon blacks having a relatively low specific surface area and relatively low DBP (Dibutyl phthalate) absorption, and microfabricated carbon blacks having a large specific surface area.

Examples of the favorable commercial products of carbon black include Printex U (registered trade mark), Printex A (registered trade mark) and Spezialschwarz 4 (registered trade mark) (all are manufactured by Degussa), SEAST 600 ISAF-LS (Tokai Carbon Co., Ltd.), Asahi #70 (N-300) (ASAHI CARBON CO., LTD.), KETJEN BLACK EC600JD (Lion Corporation), etc.

With regard to the selection of such carbon blacks, for example, “Carbon Black Handbook” edited by Carbon Black Association may be referred to.

The carbon black has preferably a spherical form. With regard to a primary particle diameter, greater than 20 nm but less than 80 nm is preferable, and greater than 25 nm but less than 70 nm is more preferable. Carbon blacks falling within the range can suppress aggregation and are excellent in dispersibility.

Examples of the inorganic fillers include alumina, titania, zirconia, kaolin, calcined kaolin, talc, pagodite, diatomite, calcium carbonate, aluminum hydroxide, magnesium hydroxide, zinc oxide, lithopone, amorphous silica, colloidal silica, calcined gypsum, silica, magnesium carbonate, titanium oxide, alumina, barium carbonate, barium sulfate, mica, etc.

The form of the filler used in the present invention is not particularly limited, but a spherical form, a layered form, a fibrous form and a hollow balloon form may be cited. Among these, a spherical form and a layered form are preferable, and a spherical form is more preferable.

An average particle diameter (average primary particle diameter) of fillers used in the present invention is preferably 10 nm to 10 μm, more preferably 10 nm to 5 μm, and particularly preferably 50 nm to 3 μm. The diameter in the above-mentioned range makes the stability of the resin composition good, and can suppress the generation of film omission after engraving to thus make the image quality excellent.

As silica used in the present invention, spherical silica particles are preferable, and commercial products shown below are exemplified preferably. Numerals in parentheses denote the average particle diameter.

Specific examples of products by EVONIK INDUSTRIES include AEROSIL RM50 (40 nm), R711 (12 nm), R7200 (12 nm), AEROSIL OX50 (40 nm), 50 (30 nm), 90G (20 nm), 130 (16 nm), 150 (14 nm), 200 (12 nm), 200 CF (12 nm), 300 (7 nm) and 380 (7 nm).

Specific examples of products by AGC Si-Tech. Co., Ltd. include SUNSPHERE H-31 (3 μm), H-51 (5 μm), H-121 (12 μm), H-201 (20 μm), SUNSPHERE L-31 (3 μm), L-51 (5 μm), SUNSPHERE NP-30 (4 μm), NP-100 (10 μm) and NP-200 (20 μm).

Specific examples of products by Nissan Chemical Industries, Ltd. include methanol silica sol (10 to 20 nm), MA-ST-M (10 to 20 nm), IPA-ST (10 to 20 nm), EG-ST (10 to 20 nm), EG-ST-ZL (70 to 100 nm), NPC-ST (10 to 20 nm), DMAC-ST (10 to 20 nm), MEK-ST (10 to 20 nm), XBA-ST (10 to 20 nm) and MIBK-ST (10 to 20 nm).

The addition amount of a filler in the resin composition for laser engraving of the present invention is, relative to the total solids content (amount excluding the solvent) of the resin composition, preferably 0.5 to 20 mass %, more preferably 1 to 15 mass %, and particularly preferably 3 to 10 mass %. When a dispersing agent such as the polymer having an ethylenically unsaturated group is employed, the total amount of the filler and the dispersing agent falls preferably within the above-mentioned addition amount.

### Polymerization Initiator

When a polymerizable compound is used as a crosslinking agent in the resin composition for laser engraving that can be used in the present invention, the resin composition preferably comprises a polymerization initiator.

With regard to the polymerization initiator, one known to a person skilled in the art may be used without any limitations. Radical polymerization initiators, which are preferred polymerization initiators, are explained in detail below, but the present invention should not be construed as being limited to these descriptions.

In the present invention, preferable polymerization initiators include (a) aromatic ketones, (b) onium salt compounds, (c) organic peroxides, (d) thio compounds, (e) hexaallylbiimidazole compounds, (f) ketoxime ester compounds, (g) borate compounds, (h) azinium compounds, (i) metallocene compounds, (j) active ester compounds, (k) compounds having a carbon halogen bond, and (l) azo compounds. Hereinafter, although specific examples of the (a) to (l) are cited, the present invention is not limited to these.

The (a) aromatic ketones, (b) onium salt compounds, (d) thio compounds, (e) hexaallylbiimidazole compounds, (f) ketoxime ester compounds, (g) borate compounds, (h) azinium compounds, (i) metallocene compounds, (j) active ester compounds, and (k) compounds having a carbon halogen bonding may preferably include compounds described in paragraphs 0074 to 0118 of JP-A-2008-63554.

A polymerization initiator can be divided into a photopolymerization initiator and a thermopolymerization initiator.

In the present invention, when applies to the relief-forming layer of the flexographic printing plate precursor, from the viewpoint of engraving sensitivity and making a favorable relief edge shape, (c) organic peroxides and (l) azo compounds which are thermopolymerization initiators are more preferable.

Moreover, (c) organic peroxides and (I) azo compounds preferably include the following compounds.

### (c) Organic Peroxide

Preferred examples of the organic peroxide (c) that can be used in the present invention include peroxyester-based ones such as 3,3′,4,4′-tetra(t-butylperoxycarbonyl)benzophenone, 3,3′,4,4′-tetra(t-amylperoxycarbonyl)benzophenone, 3,3′,4,4′-tetra(t-hexylperoxycarbonyl)benzophenone, 3,3′,4,4′-tetra(t-octylperoxycarbonyl)benzophenone, 3,3′,4,4′-tetra(cumylperoxycarbonyl)benzophenone, 3,3′,4,4′-tetra(p-isopropylcumylperoxycarbonyl)benzophenone, di-t-butyldiperoxyisophthalate, t-butyl peroxybenzoate, t-butyl peroxy-3-methyl benzoate, t-butylperoxylaurate, t-butyl peroxypivalate, t-butylperoxy-2-ethylhexanoate, t-butylperoxy-3,5,5-trimethylhexanoate, t-butylperoxyneoheptanoate, t-butyl peroxyneodecanoate, and t-butylperoxyacetate, α,α′-di(t-butylperoxy)diisopropylbenzene, t-butylcumylperoxide, di-t-butylperoxide, t-butylperoxyisopropylmonocarbonate, and t-butylperoxy-2-ethylhexylmonocarbonate.

### (l) Azo Compounds

Preferable (l) azo compounds that can be used in the present invention include those such as 2,2′-azobisisobutyronitrile, 2,2′-azobispropionitrile, 1,1′-azobis(cyclohexane-1-carbonitrile), 2,2′-azobis(2-methylbutyronitrile), 2,2′-azobis(2,4-dimethylvaleronitrile), 2,2′-azobis(4-methoxy-2,4-dimethylvaleronitrile), 4,4′-azobis(4-cyanovaleric acid), dimethyl 2,2′-azobis(isobutyrate), 2,2′-azobis(2-methylpropionamideoxime), 2,2′-azobis[2-(2-imidazolin-2-yl)propane], 2,2′-azobis{2-methyl-N-[1,1-bis(hydroxymethyl)-2-hydroxyethyl]propionamide}, 2,2′-azobis[2-methyl-N-(2-hydroxyethyl)propionamide], 2,2′-azobis(N-butyl-2-methylpropionamide), 2,2′-azobis(N-cyclohexyl-2-methylpropionamide), 2,2′-azobis[N-(2-propenyl)-2-methyl-propionamide], 2,2′-azobis(2,4,4-trimethylpentane).

The polymerization initiator in the resin composition of the present invention may be used singly or in a combination of two or more compounds.

The content of the polymerization initiator in the resin composition of the present invention is preferably 0.01 to 10 mass % relative to the total mass of the solids content, and more preferably 0.1 to 3 mass %.

### Crosslinking Promoter

When the above-mentioned ‘compound having —SiR¹R²R³′, etc. is used as a crosslinking agent in the resin composition, in order to promote a reaction between specific hydrophilic compounds or between crosslinking agents or a reaction between a binder polymer and a specific hydrophilic compound or crosslinking agent, it is preferable for a crosslinking promoter (hereinafter, also called a ‘catalyst’) to be contained.

The crosslinking promoter that can be used in the present invention is not particularly limited as long as it is a compound that can promote a crosslinking reaction with the above-mentioned ‘compound having —SiR¹R²R³’, and (1) an acidic catalyst or basic catalyst or (2) a metal complex catalyst may be used.

As the crosslinking promoter, (1) an acidic catalyst or basic catalyst is preferable. Furthermore, when a hydroxy group is involved in a reaction, from the viewpoint of crosslinking speed of the hydroxy group, a basic catalyst is particularly preferable.

### (1) Acidic Catalyst or Basic Catalyst

As the catalyst, an acidic compound or basic compound is used as it is or in the form of a solution in which it is dissolved in a solvent such as water or an organic solvent (hereinafter, also called an acidic catalyst or basic catalyst respectively). The concentration when dissolving in a solvent is not particularly limited, and it may be selected appropriately according to the properties of the acidic compound or basic compound used, desired catalyst content, etc.

The type of acidic catalyst or basic catalyst is not particularly limited; specific examples of the acidic catalyst include a hydrogen halide such as hydrochloric acid, nitric acid, sulfuric acid, sulfurous acid, hydrogen sulfide, perchloric acid, hydrogen peroxide, carbonic acid, a carboxylic acid such as formic acid or acetic acid, a carboxylic acid in which R of the structural formula RCOOH is substituted with another element or substituent, a sulfonic acid such as benzenesulfonic acid, phosphoric acid, a heteropoly acid, and an inorganic solid acid, and examples of the basic catalyst include an ammoniacal base such as aqueous ammonia, an amine such as ethylamine or aniline, an alkali metal hydroxide, an alkali metal alkoxide, an alkaline earth oxide, a quaternary ammonium salt compound, and a quaternary phosphonium salt compound.

### (2) Metal Complex Catalyst

The metal complex catalyst that can be used in the present invention is preferably a metal complex catalyst formed from a metal element selected from the group consisting of Groups 2, 4, 5, and 13 of the periodic table and an oxo or hydroxy oxygen-containing compound selected from the group consisting of 13-diketones, ketoesters, hydroxycarboxylic acids and esters thereof, amino alcohols, and enolic active hydrogen compounds.

Furthermore, among the constituent metal elements, a Group 2 element such as Mg, Ca, Sr, or Ba, a Group 4 element such as Ti or Zr, a Group 5 element such as V, Nb, or Ta, and a Group 13 element such as Al or Ga are preferable, and they form a complex having an excellent catalytic effect. Among them, a complex obtained from Zr, Al, or Ti (ethyl orthotitanate, etc.) is excellent and preferable.

The resin composition may employ only one type of crosslinking promoter or two or more types thereof in combination.

The content of the crosslinking promoter in the resin composition is preferably 0.01 to 20 parts by mass relative to 100 parts by the total mass of the solids content, and more preferably 0.1 to 15 parts by mass.

### Photothermal Conversion Agent

The resin composition for laser engraving of the present invention preferably further includes a photothermal conversion agent. That is, it is considered that the photothermal conversion agent in the present invention can promote the thermal decomposition of a cured material during laser engraving by absorbing laser light and generating heat. Therefore, it is preferable that a photothermal conversion agent capable of absorbing light having a wavelength of laser used for graving be selected.

When a laser (a YAG laser, a semiconductor laser, a fiber laser, a surface emitting laser, etc.) emitting infrared at a wavelength of 700 to 1,300 nm is used as a light source for laser engraving, it is preferable for the flexographic printing plate precursor for laser engraving which is produced by using the resin composition for laser engraving of the present invention to comprise a photothermal conversion agent that has a maximum absorption wavelength at 700 to 1,300 nm.

As the photothermal conversion agent that has a maximum absorption wavelength at 700 to 1,300 nm in the present invention, various types of dye or pigment are used.

With regard to the photothermal conversion agent that has a maximun absorption wavelength at 700 to 1,300 nm, examples of dyes that can be used include commercial dyes and known dyes described in publications such as ‘Senryo Binran’ (Dye Handbook) (Ed. by The Society of Synthetic Organic Chemistry, Japan, 1970). Specific examples include dyes having a maximum absorption wavelength at 700 to 1,300 nm, and preferable examples include azo dyes, metal complex salt azo dyes, pyrazolone azo dyes, naphthoquinone dyes, anthraquinone dyes, phthalocyanine dyes, carbonium dyes, diimmonium compounds, quinone imine dyes, methine dyes, cyanine dyes, squarylium colorants, pyrylium salts, and metal thiolate complexes. In particular, cyanine-based colorants such as heptamethine cyanine colorants, oxonol-based colorants such as pentamethine oxonol colorants, and phthalocyanine-based colorants are preferably used. Examples include dyes described in paragraphs 0124 to 0137 of JP-A-2008-63554.

With regard to the photothermal conversion agent used in the present invention, examples of pigments include commercial pigments and pigments described in the Color Index (C.I.) Handbook, ‘Saishin Ganryo Binran’ (Latest Pigments Handbook) (Ed. by Nippon Ganryo Gijutsu Kyokai, 1977), ‘Saishin Ganryo Ouyogijutsu’ (Latest Applications of Pigment Technology) (CMC Publishing, 1986), ‘Insatsu Inki Gijutsu’ (Printing Ink Technology) (CMC Publishing, 1984). Examples of pigments include pigments described in paragraphs 0122 to 0125 of JP-A-2009-178869.

Among these pigments, carbon black is preferable.

Carbon black has not only the function as the filler described above, but also a function as a photothermal conversion agent capable of absorbing light having a wavelength of 700 nm to 1,300 nm. Thus, carbon black is particularly preferably used in the resin composition for laser engraving that is used in the present invention.

The photothermal conversion agent in the resin composition of the present invention may be used singly or in a combination of two or more compounds.

The content of the photothermal conversion agent in the resin composition for laser engraving of the present invention may vary greatly with the magnitude of the molecular extinction coefficient inherent to the molecule, but the content is preferably 0.01 to 30 mass %, more preferably 0.05 to 20 mass %, and particularly preferably 0.1 to 10 mass %, relative to the total mass of the resin composition.

### Other Additives

The resin composition for laser engraving that can be used in the present invention may comprise as appropriate various types of known additives as long as the effects of the present invention are not inhibited. Examples include a plasticizer, a wax, an a metal oxide, an antiozonant, an anti-aging agent, a thermopolymerization inhibitor, a colorant and a fragrance, and one type thereof may be used on its own or two more types may be used in combination.

### (Process For Producing a Flexographic Printing Plate Precursor for Laser Engraving)

The process for producing a flexographic printing plate precursor for laser engraving of the present invention is preferably a production process comprising a layer forming step of forming a relief-forming layer composed of a resin composition for laser engraving; a crosslinking step of thermally crosslinking the relief-forming layer to obtain a crosslinked relief-forming layer; and a matting agent forming step of forming matting agent particles at the surface of the relief-forming layer or the crosslinked relief-forming layer.

### <Layer Formation Step>

The process for producing the flexographic printing plate precursor for laser engraving of the present invention preferably comprises a layer formation step of forming a relief-forming layer from the resin composition for laser engraving of the present invention.

Preferred examples of a method for forming the relief-forming layer include a method in which the resin composition for laser engraving of the present invention is prepared, solvent is removed as necessary from this resin composition for laser engraving, and it is then melt-extruded onto a support and a method in which the resin composition for laser engraving of the present invention is prepared, the resin composition for laser engraving of the present invention is cast onto a support, and this is dried in an oven to thus remove solvent.

The resin composition for laser engraving that is used in the present invention can be prepared by dissolving, for example, a binder polymer, a filler, a fragrance, a plasticizer and the like in an appropriate solvent, and then dissolving a crosslinking agent, a polymerization initiator, a crosslinking accelerator and the like therein. Since most of the solvent component needs to be removed in the stage of producing a flexographic printing plate precursor, the solvent is preferably an organic solvent which easily volatilizes, and it is preferable to suppress the total amount of the solvent added to the minimum as far as possible by adjusting the temperature or the like.

Specific preferred examples of the aprotic organic solvent include acetonitrile, tetrahydrofuran, dioxane, toluene, propylene glycol monomethyl ether acetate, methyl ethyl ketone, acetone, methyl isobutyl ketone, ethyl acetate, butyl acetate, ethyl lactate, N,N-dimethylacetamide, N-methylpyrrolidone, and dimethyl sulfoxide.

Specific preferred examples of the protic organic solvent include methanol, ethanol, 1-propanol, 2-propanol, 1-butanol, 1-methoxy-2-propanol, ethylene glycol, diethylene glycol, and 1,3-propanediol.

Among these, propylene glycol monomethyl ether acetate is preferable.

### <Crosslinking Step>

The process for producing the flexographic printing plate precursor for laser engraving of the present invention is preferably a production process comprising a crosslinking step of thermally crosslinking the relief-forming layer to thus obtain a relief printing starting plate having a crosslinked relief-forming layer.

The relief-forming layer may be crosslinked by heating the relief printing starting plate for laser engraving (step of crosslinking by means of heat). As heating means for carrying out crosslinking by heat, there can be cited a method in which a printing starting plate is heated in a hot air oven or an infrared oven for a predetermined period of time and a method in which it is put into contact with a heated roller for a predetermined period of time.

Due to the relief-forming layer being thermally crosslinked, firstly, a relief formed after laser engraving becomes sharp and, secondly, anti-tackiness of engraving residue formed when laser engraving is suppressed.

### <Matting Agent Forming Step>

The process for producing a flexographic printing plate precursor for laser engraving of the present invention is preferably a production process including a matting agent forming step of forming matting agent particles at the surface of the relief-forming layer or the crosslinked relief-forming layer.

The process for producing a flexographic printing plate precursor for laser engraving of the present invention is more preferably a production process including a matting agent forming step based on a method in which an aqueous solution or an aqueous dispersion of a water-soluble resin or an alkaline resin used in the present invention is made to adhere to the surface of the relief-forming layer or the crosslinked relief-forming layer by spraying, and then the aqueous solution or aqueous dispersion is dried by warm air or the like; a method in which, by spray drying in which spraying is accompanied by drying, matting agent particles are made to adhere to the surface of the relief-forming layer or the crosslinked relief-forming layer, while the matting agent particles being formed, and then drying is completed; or the like.

The matting agent forming step may be carried out between the layer forming step of forming a relief-forming layer and the crosslinking step, or may be carried out after the crosslinking step.

An aqueous solution of the specific resin that is used in the present invention can be prepared by converting the specific resin into a sodium salt, a potassium salt or an ammonium salt, and dissolving the salt in an aqueous alkali solution. Furthermore, as described above, synthesis of the copolymer that is used in the present invention may be carried out by a latex synthesis method, and thus the copolymer may be obtained as an aqueous dispersion.

The concentration of the resin in the aqueous solution or aqueous dispersion of the specific resin that is used in the present invention is preferably within a range of 10 mass % to 30 mass %, and more preferably within a range of 15 mass % to 25 mass %.

The aqueous solution or aqueous dispersion of the specific resin that is used in the present invention is sprayed and made to adhere to the surface of the relief-forming layer or the crosslinked relief-forming layer by spraying in the matting agent forming step. Spraying can be carried out by a known method such as an air spray method, an airless spray method, an electrostatic air spray method, or an electrostatic atomization electrostatic coating method.

The size of droplets of the aqueous liquid that is sprayed by spraying may be an arbitrary size, so long as the number average particle size of the matting agent particles that are formed on the surface of the relief-forming layer is preferably within a range of 2 μm to 40 μm. By controlling the method of spraying, the particle size, adhesion amount, and adhesion density of the matting agent particles that are made to adhere to the surface of the relief-forming layer can be controlled.

The droplets of the aqueous liquid of the specific resin that is used in the present invention, which have been sprayed and made to adhere to the surface of the relief-forming layer are then preferably dried. Drying may be carried out by a conventional method, for example, a method of blowing warm air. In this manner, the resin droplets which have been made to adhere to the surface of the relief-forming layer become matting agent particles, and are mattified at the surface of the relief-forming layer and fixed thereto.

Furthermore, drying may be carried out in the course of spraying of the aqueous liquid to the surface of the relief-forming layer, and a method in which, during spray drying, droplets of the specific resin are made to adhere to the surface of the relief-forming layer while matting agent particles being formed, and then drying is completed, is also preferable.

In the case where the aqueous liquid is sprayed and dried as described above, since the liquid droplets that are micronized by spraying adhere to the surface of the relief-forming layer, the drying speed is fast, and therefore, the resin is sufficiently dried and hardened in a relatively short time after spraying. Besides, since the matting agent particles are made to adhere strongly (fixed) to the surface of the relief-forming layer, it is thought that the matting agent particles undergo less peeling or detachment.

The above-mentioned method involving spraying of an aqueous liquid is advantageous in that there is no risk of explosion that occurs in a method in which spraying is performed by using an organic solvent, and there is no need to provide explosion-proof facilities.

### (Flexographic Printing Plate and Process for Making the Same)

The process for making a flexographic printing plate of the present invention preferably comprises a layer forming step of forming a relief-forming layer comprising a resin composition for laser engraving; a crosslinking step of thermally crosslinking the relief-forming layer to obtain a crosslinked relief-forming layer; a matting agent forming step of forming matting agent particles at the surface of the relief-forming layer or the crosslinked relief-forming layer; and an engraving step of laser-engraving the flexographic printing plate precursor having the crosslinked relief-forming layer.

The flexographic printing plate of the present invention is a flexographic printing plate having a relief layer that is obtained by crosslinking and laser-engraving a relief-forming layer formed from a resin composition for laser engraving, and the flexographic printing plate is preferably made by the process for making a flexographic printing plate of the present invention.

For the flexographic printing plate of the present invention, a UV ink and an aqueous ink can be suitably used in printing.

The layer forming step, crosslinking step and matting agent forming step in the process for making a flexographic printing plate of the present invention respectively have the same definitions as the layer forming step, crosslinking step and matting agent forming step in the process for producing a flexographic printing plate precursor for laser engraving, and the preferred ranges are also the same.

### <Engraving Step>

The process for producing a flexographic printing plate of the present invention preferably comprises an engraving step of laser-engraving the flexographic printing plate precursor having a crosslinked relief-forming layer.

The engraving step is a step of laser-engraving a crosslinked relief-forming layer that has been crosslinked in the crosslinking step to thus form a relief layer. Specifically, it is preferable to engrave a crosslinked relief-forming layer that has been crosslinked with laser light according to a desired image, thus forming a relief layer. Furthermore, a step in which a crosslinked relief-forming layer is subjected to scanning irradiation by controlling a laser head using a computer in accordance with digital data of a desired image can preferably be cited.

This engraving step preferably employs an infrared laser. When irradiated with an infrared laser, molecules in the crosslinked relief-forming layer undergo molecular vibration, thus generating heat. When a high power laser such as a carbon dioxide laser or a YAG laser is used as the infrared laser, a large quantity of heat is generated in the laser-irradiated area, and molecules in the crosslinked relief-forming layer undergo molecular scission or ionization, thus being selectively removed, that is, engraved. The advantage of laser engraving is that, since the depth of engraving can be set freely, it is possible to control the structure three-dimensionally. For example, for an area where fine halftone dots are printed, carrying out engraving shallowly or with a shoulder prevents the relief from collapsing due to printing pressure, and for a groove area where a fine outline character is printed, carrying out engraving deeply makes it difficult for ink the groove to be blocked with ink, thus enabling breakup of an outline character to be suppressed.

In particular, when the resin composition comprises a photothermal conversion agent having a photo absorption in infrared wavelength range and engraving is carried out using an infrared laser, it becomes possible to selectively remove the crosslinked relief-forming layer at higher sensitivity, thus giving a relief layer having a sharp image.

As the infrared laser used in the engraving step, from the viewpoint of productivity, cost, etc., a carbon dioxide laser (a CO₂ laser) or a semiconductor laser is preferable. In particular, a fiber-coupled semiconductor infrared laser (FC-LD) is preferably used. In general, compared with a CO₂ laser, a semiconductor laser has higher efficiency laser oscillation, is less expensive, and can be made smaller. Furthermore, it is easy to form an array due to the small size. Moreover, the shape of the beam can be controlled by treatment of the fiber.

With regard to the semiconductor laser, one having a wavelength of 700 to 1,300 nm is preferable, one having a wavelength of 800 to 1,200 nm is more preferable, one having a wavelength of 860 to 1,200 nm is yet more preferable, and one having a wavelength of 900 to 1,100 nm is particularly preferable.

Furthermore, the fiber-coupled semiconductor laser can output laser light efficiently by being equipped with optical fiber, and this is effective in the engraving step in the present invention. Moreover, the shape of the beam can be controlled by treatment of the fiber. For example, the beam profile may be a top hat shape, and energy can be applied stably to the plate face. Details of semiconductor lasers are described in ‘Laser Handbook 2^{nd} Edition’ The Laser Society of Japan, Applied Laser Technology, The Institute of Electronics and Communication Engineers, etc.

Moreover, as plate making equipment comprising a fiber-coupled semiconductor laser that can be used suitably in the process for making a flexographic printing plate employing the flexographic printing plate precursor of the present invention, those described in detail in JP-A-2009-172658 and JP-A-2009-214334 can be cited. Such equipment comprising a fiber-coupled semiconductor laser can be used to produce a flexographic printing plate of the present invention.

The process for producing a flexographic printing plate of the present invention may as necessary further comprise, subsequent to the engraving step, a rinsing step, a drying step, and/or a post-crosslinking step, which are shown below.

Rinsing step: a step of rinsing the engraved surface by rinsing the engraved relief layer surface with water or a liquid comprising water as a main component.

Drying step: a step of drying the engraved relief layer.

Post-crosslinking step: a step of further crosslinking the relief layer by applying energy to the engraved relief layer.

After the above-mentioned step, since engraved residue is attached to the engraved surface, a rinsing step of washing off engraved residue by rinsing the engraved surface with water or a liquid comprising water as a main component may be added. Examples of rinsing means include a method in which washing is carried out with tap water, a method in which high pressure water is spray-jetted, and a method in which the engraved surface is brushed in the presence of mainly water using a batch or conveyor brush type washout machine known as a photosensitive resin letterpress plate processor, and when slime due to engraved residue cannot be eliminated, a rinsing liquid to which a soap or a surfactant is added may be used.

When the rinsing step of rinsing the engraved surface is carried out, it is preferable to add a drying step of drying an engraved relief-forming layer so as to evaporate rinsing liquid.

Furthermore, as necessary, a post-crosslinking step for further crosslinking the relief-forming layer may be added. By carrying out a post-crosslinking step, which is an additional crosslinking step, it is possible to further strengthen the relief formed by engraving.

The pH of the rinsing liquid that can be used in the present invention is preferably at least 9, more preferably at least 10, and yet more preferably at least 11. The pH of the rinsing liquid is preferably no greater than 14, more preferably no greater than 13, and yet more preferably no greater than 12.5. When in the above-mentioned range, handling is easy.

In order to set the pH of the rinsing liquid in the above-mentioned range, the pH may be adjusted using an acid and/or a base as appropriate, and the acid or base used is not particularly limited.

The rinsing liquid that can be used in the present invention preferably comprises water as a main component.

The rinsing liquid may contain as a solvent other than water a water-miscible solvent such as an alcohol, acetone, or tetrahydrofuran.

The rinsing liquid preferably comprises a surfactant.

From the viewpoint of removability of engraved residue and little influence on a flexographic printing plate, preferred examples of the surfactant that can be used in the present invention include betaine compounds (amphoteric surfactants) such as a carboxybetaine compound, a sulfobetaine compound, a phosphobetaine compound, an amine oxide compound, and a phosphine oxide compound.

Furthermore, examples of the surfactant also include known anionic surfactants, cationic surfactants, and nonionic surfactants. Moreover, a fluorine-based or silicone-based nonionic surfactant may also be used in the same manner.

With regard to the surfactant, one type may be used on its own or two or more types may be used in combination.

It is not necessary to particularly limit the amount of surfactant used, but it is preferably 0.01 to 20 mass % relative to the total mass of the rinsing liquid, and more preferably 0.05 to 10 mass %.

Furthermore, the Shore A hardness of the relief layer of the flexographic printing plate is preferably at least 50° but no greater than 90°. When the Shore A hardness of the relief layer is at least 50°, even if fine halftone dots formed by engraving receive a strong printing pressure from a letterpress printer, they do not collapse and close up, and normal printing can be carried out. Furthermore, when the Shore A hardness of the relief layer is no greater than 90°, even for flexographic printing with kiss touch printing pressure it is possible to prevent patchy printing in a solid printed part.

The Shore A hardness in the present specification is a value measured by a durometer (a spring type rubber hardness meter) that presses an indenter (called a pressing needle or indenter) into the surface of a measurement target at 25° C. so as to deform it, measures the amount of deformation (indentation depth), and converts it into a numerical value.

The flexographic printing plate of the present invention is particularly suitable for printing by a flexographic printer using a UV ink, but printing is also possible when it is carried out by a letterpress printer using any of aqueous, oil-based, and UV inks, and printing is also possible when it is carried out by a flexographic printer using an aqueous ink. The flexographic printing plate of the present invention has excellent rinsing properties, there is no engraved residue, since a relief layer obtained has excellent elasticity aqueous ink and UV ink transfer properties and printing durability are excellent, and printing can be carried out for a long period of time without plastic deformation of the relief layer or degradation of printing durability.

In accordance with the present invention, there can be provided a flexographic printing plate precursor for laser engraving which exhibits less detachment of a matting agent and has excellent plate anti-tackiness, a process for producing the same, a process for making a flexographic printing plate using the printing plate precursor, and a flexographic printing plate obtained by the process.

### EXAMPLES

The present invention is explained in further detail below by reference to Examples, but the present invention should not be construed as being limited to these Examples. Furthermore, ‘parts’ in the description below means ‘parts by mass’, and ‘%’ means ‘% by mass’, unless otherwise specified.

Moreover, the weight-average molecular weight (Mw) of a polymer in the Examples are values measured by a GPC method unless otherwise specified.

### Preparation Example 1

### Preparation Example of Polyurethane Resin A

In a separable flask equipped with a thermometer, a stirrer and a reflux condenser, 447.24 parts of ‘PCDL L4672’ (trade name, weight average molecular weight: 1,990, OH value: 56.4), which is a polycarbonate diol manufactured by Asahi Kasei Corp. and 30.83 parts of tolylene diisocyanate (manufactured by Tokyo Chemical Industry Co., Ltd.) were introduced, and the mixture was allowed to react for about 3 hours under heating at 80° C. Subsequently, 14.83 parts of 2-methacryloyloxyethyl isocyanate (KARENZ MOI, manufactured by Showa Denko K.K.) was added thereto, and the mixture was further allowed to react for about 3 hours. Thus, polyurethane resin A having a weight average molecular weight of about 10,000 and having methacryl groups at the ends (with about two polymerizable unsaturated groups per molecule on the average) was produced.

### Preparation Example 2

### Preparation Example of Copolymer-1 (Copolymerization Ratio A)

The inside of a flask equipped with a mechanical stirrer, a thermometer, a nitrogen gas inlet tube, a reflux tube and a dropping funnel was sufficiently purged with nitrogen gas, and then 2.7 parts of LATEMUL S-180 (reactive emulsifier having unsaturated carbon, manufactured by Kao Corp., component: 100 mass %) and 210.8 parts of ion-exchanged water were introduced into the flask and mixed. The mixture was heated to 65° C. After the temperature rising, 1.0 part of t-butyl peroxybenzoate (manufactured by Tokyo Chemical Industry Co., Ltd.), which is a polymerization initiator, and 0.3 parts of sodium isoascorbate (manufactured by Tokyo Chemical Industry Co., Ltd.) were added to the mixture. After 5 minutes, 68 parts of methyl methacrylate (manufactured by Tokyo Chemical Industry Co., Ltd.), 20 parts of ethyl acrylate (manufactured by Tokyo Chemical Industry Co., Ltd.), 12 parts of sodium acrylate (manufactured by Tokyo Chemical Industry Co., Ltd.), 2.7 parts of LATEMUL S-180, and 210.8 parts of ion-exchanged water were mixed, and the mixture was added dropwise to the flask over 3 hours. Thereafter, aging by heating was carried out for 2 hours at 80° C., subsequently the mixture was cooled to normal temperature, and the pH was adjusted to 7 to 8 with sodium hydroxide. Ethanol was distilled off by using an evaporator, and the moisture content was adjusted. Thus, 527 parts of an aqueous dispersion of copolymer-1 (copolymerization ratio A) having a solid content of 20 mass % was prepared.

### Preparation Example 3

### Preparation Example of Copolymer-1 (Copolymerization Ratio B)

Copolymer-1 was produced in the same manner as in the process for producing copolymer-1 of Preparation Example 2, except that the amounts of methyl methacrylate, ethyl acrylate and sodium acrylate which are raw material monomers were changed to 80 parts, 8 parts, and 12 parts, respectively. Thus, 527 parts of an aqueous dispersion of copolymer-1 (copolymerization ratio B) having a solid content of 20 mass % was prepared.

### Preparation Example 4

### Preparation Example of Copolymer-2 (Copolymerization Ratio C)

Copolymer-2 was produced in the same manner as in the process for producing copolymer-1 of Preparation Example 2, except that methyl methacrylate, ethyl acrylate and sodium acrylate which are raw material monomers were changed to the raw material monomers described below with the amounts described below. Thus, 527 parts of an aqueous dispersion of copolymer-2 (copolymerization ratio C) having a solid content of 20 mass % was prepared.

Methyl methacrylate 50 parts

Styrene (manufactured by Tokyo Chemical Industry Co., Ltd.) 10 parts

Ethyl acrylate 31 parts

Methacrylic acid sodium salt (manufactured by Wako Pure Chemical Industries, Ltd.) 9 parts

### Preparation Examples 5 and 6

### Preparation Examples of Copolymer-1 (Copolymerization Ratios D and E)

Copolymers of copolymerization ratios D and E were produced in the same manner as in Preparation Example 2, except that the copolymerization ratio of monomer unit (a) derived from ethyl acrylate, monomer unit (b) derived from methyl methacrylate, and monomer unit (c) derived from sodium acrylate used in the process for producing copolymer-1 of Preparation Example 2 was changed to a:b:c=8:87:5 (copolymerization ratio D) and 0:0:100 (copolymerization ratio E) respectively.

### <Preparation of Aqueous Dispersion of Water-Soluble Resin>

The aqueous dispersions of copolymers obtained in Preparation Examples 2 to 6 were used as the aqueous dispersion having a solid content of 20 mass %.

### Example 1

### 1. Preparation of Resin Composition 1 for Laser Engraving

In a three-necked flask equipped with a stirring blade and a cooling tube, 50 parts of polyurethane resin A as a binder polymer, and 47 parts of propylene glycol monomethyl ether acetate (manufactured by Tokyo Chemical Industry Co., Ltd.) as a solvent were introduced, the mixture was heated at 70° C. for 120 minutes while being stirred, and thus the polymer was dissolved. Thereafter, the solution was heated to 40° C., and 15 parts of tributyl citrate (manufactured by Tokyo Chemical Industry Co., Ltd.) as a plasticizer, 8 parts of BLENMER LMA (lauryl methacrylate, manufactured by NOF Corp.) as a polymerizable compound of crosslinking agent (1), and 1.6 parts of PERBUTYL Z (manufactured by NOF Corp.) as a polymerization initiator were added to the solution. The mixture was stirred for 30 minutes. Thereafter, 15 parts of bis(triethoxysilylpropyl)tetrasulfide (KBE-846, manufactured by Shin-Etsu Chemical Co. Ltd.) as a crosslinking agent having —SiR¹R²R³ of crosslinking agent (2) and 0.4 parts of phosphoric acid as a crosslinking promoter (catalyst) were added to the mixture, and the resulting mixture was stirred for 10 minutes at 40° C. A coating liquid 1 for relief-forming layer (resin composition 1 for laser engraving) having fluidity was obtained by this operation.

### 2. Production of Flexographic Printing Plate Precursor 1 for Laser Engraving

A spacer (frame) having a predetermined thickness was installed on a PET substrate, and the coating liquid 1 for relief-forming layer obtained as described above was gently flow cast to the extent that the coating liquid would not flow out over the spacer (frame). Thus, a relief-forming layer having a thickness of approximately 1 mm was provided.

Subsequently, the aqueous liquid of copolymer (copolymer-1) having the composition described above, which was prepared at a solid concentration of the resin of 20%, was sprayed on the surface of the relief-forming layer by an electrostatic air type spray manufactured by Graco, Inc., and thereby droplets were made to adhere to the surface of the relief-forming layer. The droplets were dried by blowing warm air at 60° C. for 5 seconds. The coating amount of the solid content of the copolymer thus made to adhere was 0.18 g/m², the number of the particles of copolymer-1 (matting agent) protruded at the surface of the relief-forming layer after drying was 50 to 100 particles/mm², the average value of the height of the matting agent particles protruded at the surface of the relief-forming layer was 5 μm, and the average value of the width of the matting agent particles (number average particle size) was 30 μm. In this manner, flexographic printing plate precursor 1 for laser engraving was produced.

The height of the matting agent particles was measured by using SURFCOM 130A (manufactured by Tokyo Seimitsu Co., Ltd.), and the number average particle size of the matting agent particles was measured from an image observed with a digital microscope, VHX-100 (manufactured by Keyence PLC).

### 3. Making of Flexographic Printing Plate 1

The relief-forming layer of the precursor thus obtained was heated for 3 hours at 100° C. to thermally crosslink the relief-forming layer. The spacer and PET were removed and peeled off from printing plate precursor 1 for laser engraving, and then the relief-forming layer after being crosslinked (surface of PET side) was subjected to laser engraving. In Example 1, and Examples 2 to 14 and Comparative Examples 1 to 6 that will be described below, when a photothermal conversion agent capable of absorbing light having a wavelength of 700 nm to 1,300 nm was added, engraving was carried out by using a semiconductor laser, and when the photothermal conversion agent was not added, engraving was carried out by using a carbon dioxide gas laser.

As a semiconductor laser engraving machine, a laser recording apparatus equipped with a fiber-coupled semiconductor laser (FC-LD) SDL-6390 (manufactured by JDSU Corp., wavelength: 915 nm) having a maximum output power of 8.0 W was used, and engraving was carried out under the conditions of a laser output power of 7.5 W, a head speed of 409 mm/sec and a pitch of 2,400 DPI. DPI means dots per inch.

As a carbon dioxide gas laser engraving machine, HELIOS 6010 (manufactured by STORK Corp.) was used, and engraving was carried out at 12,000 rotations/min.

The engraving pattern was a pattern including a line drawing with convex lines having a width of 500 μm, and outlined lines having a width of 500 μm. The engraving depth was set to 500 μm.

The flexographic printing plate obtained after being laser-engraved as described above was further subjected to a rinsing step as described below.

### Preparation of Rinsing Liquid

A rinsing liquid was prepared by adding dropwise a 48% aqueous solution of NaOH (manufactured by Wako Pure Chemical Industries, Ltd.) to 500 parts of pure water to adjust the pH to a predetermined pH.

Thereafter, as necessary, SOFTAZOLINE LAO (manufactured by Kawaken Fine Chemicals Co., Ltd., lauric acid amide propyldimethylamine oxide) was further added thereto in an amount of 0.1 mass % relative to the total mass, and the mixture was stirred for 30 minutes. Thus, a rinsing liquid was prepared.

### Rinsing Step

On the flexographic printing plate engraved by the method described above, the rinsing liquid prepared by the method described above was dropped with a dropper (about 100 ml/m²) such that the plate surface would be uniformly wetted, and after allowing the plate to stand for 1 minute, the plate was rubbed 20 times (for 30 seconds) in parallel thereto under a load of 200 gf by use of a toothbrush (CLINICA TOOTHBRUSH FLAT of Lion Corp.). Thereafter, the plate surface was washed with flowing water, moisture was removed from the plate surface, and the plate was naturally dried for about 1 hour.

### Example 2

Resin composition for laser engraving 2, flexographic printing plate precursor for laser engraving 2 and flexographic printing plate 2 were obtained in the same manner as in Example 1, except that 3 parts of carbon black (SHO BLACK N110, manufactured by Cabot Japan K.K., DBP oil absorption: 115 ml/100 g) was further added as a filler to the components used in Example 1.

### Examples 3 to 14 and Comparative Examples 1 to 6

Resin composition for laser engraving, flexographic printing plate precursors for laser engraving and flexographic printing plates were obtained for Examples 3 to 14 and Comparative Examples 1 to 6, respectively, in the same manner as in Example 1, except that among the components used in Example 1, the amounts in parts per mass of the binder polymer, the matting agent and the filler were changed as indicated in Table 1.

Example 7 was produced in the same manner as in Example 2, except that the amount of spraying, the spraying time, and the like of copolymer-1 were adjusted such that the average value of the width (number average particle size) of the matting agent particles would be 3 μm.

Example 8 was produced in the same manner as in Example 2, except that the amount of spraying, the spraying time, and the like of copolymer-1 were adjusted such that the average value of the width (number average particle size) of the matting agent particles would be 35 μm.

Comparative Example 3 was produced in the same manner as in Example 2, except that copolymer-1 of Example 2 was changed to an inorganic matting agent (silica).

Comparative Example 4 was produced in the same manner as in Example 2, except that copolymer 1 of Example 2 was changed to an organic matting agent (PM MA).

Comparative Examples 5 and 6 were produced in the same manner as in Example 2, except that the amount of spraying, the spraying time and the like of copolymer-1 were adjusted such that the average values of the width (number average particle size) of the matting agent particles were changed to 1 μm and 50 μm, respectively.

### (Evaluation)

Examples 1 to 14 and Comparative Examples 1 to 6 obtained as described above were evaluated for anti-tackiness and the detachment of the matting agent. The results are shown in Table 1.

### <Evaluation of Anti-Tackiness>

A PET film specimen having a size of 3×3 cm² was pressed on the surface of a flexographic printing plate precursor thus obtained, under a certain weight applied (100 g/cm²) for a certain time (for 1 minute). The evaluation of anti-tackiness was carried out on the basis of the state of peeling of the PET film specimen.

The evaluation criteria were as follows.

A: PET did not adhere to the plate, and even though the plate and the PET were rubbed together, there was no sense of resistance caused by adhesion between the two materials.

B: PET did not adhere to the plate, but when the plate and the PET were rubbed together, there was a slight sense of resistance cause between the two materials.

C: PET adhered to the plate for a moment, but the PET peeled off within 5 seconds.

D: PET adhered to the plate but slowly peeled off (longer than 5 seconds and within 30 seconds).

E: PET adhered to the plate and did not peel off within 60 seconds.

Grade C or higher was considered as a practically acceptable level.

### <Evaluation of Detachment of Matting Agent>

In an evaluation of the detachment of the matting agent, a PET film specimen having a size of 3×3 cm² was superimposed on the surface of a flexographic printing plate precursor thus obtained. An operation in which the PET film is shifted for 10 cm at a rate of 10 cm/min under a load applied of 100 gf/cm² was repeated 20 times, and then the number of the matting agent particles was counted by observing the surface of the flexographic printing plate precursor using an optical microscope. Thus, the flexographic printing plate precursor was evaluated on the basis of the following criteria.

A: There was no detachment of the matting agent.

B: Detachment of the matting agent occurred at a ratio of less than 20%.

C: Detachment of the matting agent occurred at a ratio of 20% or higher.

Grade B or higher was considered as a practically acceptable level.

A sample obtained by producing a printing plate precursor by changing the order of the matting agent forming step of Example 1 from between the relief-forming layer forming step and the crosslinking step to after the crosslinking step, was evaluated. The same results as those obtained in Example 1 were obtained.

TABLE 1

| | | | Matting | | | | |
|---|---|---|---|---|---|---|---|
| | | | agent | | | | |
| | | | particle | | | | Detachment |
| | | | size | | | Anti- | of matting |
| | Binder polymer | Kind of matting agent | (μm) | Crosslinking agent | Filler | tackiness | agent |
| Example 1 | Polyurethane resin A | Copolymer-1 | 30 | BLENMER-LMA KBM-846 | — | B | A |
| | | (Copolymerization | | | | | |
| | | ratio A) | | | | | |
| Example 2 | Polyurethane resin A | Copolymer-1 | 30 | BLENMER-LMA KBM-846 | SHO BLACK N110 | A | A |
| | | (Copolymerization | | | | | |
| | | ratio A) | | | | | |
| Example 3 | Polyurethane resin A | Copolymer-1 | 30 | BLENMER-LMA KBM-846 | AEROSIL 200CF | B | A |
| | | (Copolymerization | | | | | |
| | | ratio A) | | | | | |
| Example 4 | DENKA BUTYRAL | Copolymer-1 | 30 | BLENMER-LMA KBM-846 | — | C | A |
| | #3000-2 | (Copolymerization | | | | | |
| | | ratio A) | | | | | |
| Example 5 | DENKA BUTYRAL | Copolymer-1 | 30 | BLENMER-LMA KBM-846 | SHO BLACK N110 | B | A |
| | #3000-2 | (Copolymerization | | | | | |
| | | ratio A) | | | | | |
| Example 6 | DENKA BUTYRAL | Copolymer-1 | 30 | BLENMER-LMA KBM-846 | AEROSIL 200CF | C | A |
| | #3000-2 | (Copolymerization | | | | | |
| | | ratio A) | | | | | |
| Example 7 | Polyurethane resin A | Copolymer-1 | 3 | BLENMER-LMA KBM-846 | SHO BLACK N110 | C | A |
| | | (Copolymerization | | | | | |
| | | ratio A) | | | | | |
| Example 8 | Polyurethane resin A | Copolymer-1 | 35 | BLENMER-LMA KBM-846 | SHO BLACK N110 | A | B |
| | | (Copolymerization | | | | | |
| | | ratio A) | | | | | |
| Example 9 | Polyurethane resin A | Copolymer-1 | 30 | BLENMER-LMA KBM-846 | SHO BLACK N110 | A | A |
| | | (Copolymerization | | | | | |
| | | ratio B) | | | | | |
| Example 10 | Polyurethane resin A | Copolymer-2 | 30 | BLENMER-LMA KBM-846 | SHO BLACK N110 | A | A |
| | | (Copolymerization | | | | | |
| | | ratio C) | | | | | |
| Example 11 | Polyurethane resin A | PVA102 | 30 | BLENMER-LMA KBM-846 | SHO BLACK N110 | C | B |
| Example 12 | Polyurethane resin A | GOHSERAN L-3266 | 30 | BLENMER-LMA KBM-846 | SHO BLACK N110 | C | A |
| Example 13 | Polyurethane resin A | Copolymer-1 | 30 | BLENMER-LMA KBM-846 | SHO BLACK N110 | B | B |
| | | (Copolymerization | | | | | |
| | | ratio D: | | | | | |
| | | a:b:c = 8:87:5) | | | | | |
| Example 14 | Polyurethane resin A | Copolymer-1 | 30 | BLENMER-LMA KBM-846 | SHO BLACK N110 | C | B |
| | | (Copolymerization | | | | | |
| | | ratio E: | | | | | |
| | | a:b:c = 0:0:100) | | | | | |
| Comp. Ex. 1 | Polyurethane resin A | — | — | BLENMER-LMA KBM-846 | — | E | A |
| Comp. Ex. 2 | Polyurethane resin A | — | — | BLENMER-LMA KBM-846 | SHO BLACK N110 | D | A |
| Comp. Ex. 3 | Polyurethane resin A | AEROSIL 200CF | 0.012 | BLENMER-LMA KBM-846 | SHO BLACK N110 | C | C |
| Comp. Ex. 4 | Polyurethane resin A | TAFTIC FH-S005 | 5 | BLENMER-LMA KBM-846 | SHO BLACK N110 | D | A |
| Comp. Ex. 5 | Polyurethane resin A | Copolymer-1 | 1 | BLENMER-LMA KBM-846 | SHO BLACK N110 | D | A |
| | | (Copolymerization | | | | | |
| | | ratio A) | | | | | |
| Comp. Ex. 6 | Polyurethane resin A | Copolymer-1 | 50 | BLENMER-LMA KBM-846 | SHO BLACK N110 | A | C |
| | | (Copolymerization | | | | | |
| | | ratio A) | | | | | |

The compounds used in the Examples and the Comparative Examples will be described below.
(Binder polymer)
Polyurethane resin A: Synthesized by the method of Preparation Example 1, weight average molecular weight (Mw) = 10,000
DENKA BUTYRAL #3000-2: Polyvinyl butyral derivative, manufactured by Denki Kagaku Kogyo K.K., weight average molecular weight (Mw) = 90,000
(Matting agent)
Copolymer-1 (copolymerization ratio A): Synthesis method described in Preparation Example 2
Copolymer-1 (copolymerization ratio B): Synthesis method described in Preparation Example 3
Copolymer-2 (copolymerization ratio C): Synthesis method described in Preparation Example 4
Copolymer-1 (copolymerization ratios D and E): Synthesis methods described in Preparation Examples 5 and 6
PVA102: Polyvinyl alcohol, manufactured by Kuraray Co., Ltd.
GOHSERAN L-3266: Polyvinyl alcohol having a sulfonic acid group, manufactured by Nippon Synthetic Chemical Industry Co., Ltd.
Inorganic silica: AEROSIL 200CF, manufactured by Nippon Aerosil Co., Ltd., number average particle size: 12 nm
Organic matting agent: PMMA, TAFTIC FH-S005, manufactured by Toyobo Co., Ltd., number average particle size: 5 μm
(filler)
Carbon black: SHO BLACK N110, manufactured by Cabot Japan K.K., photothermal conversion agent
Inorganic silica: AEROSIL 200CF, manufactured by Nippon Aerosil Co., Ltd., number average particle size: 12 nm
(crosslinking agent)
Polymerizable compound: BLENMER LMA, lauryl methacrylate, manufactured by NOF Corp.
Crosslinking agent having —SiR¹R²R³: Bis(triethoxysilylpropyl) tetrasulfide, KBE-846, manufactured by Shin-Etsu Chemical Co., Ltd.
(Other additives)
Polymerization initiator: t-Butyl peroxybenzoate, manufactured by Tokyo Chemical Industry Co., Ltd.
Polymerization initiator: PERBUTYL Z, manufactured by NOR Corp.
Crosslinking promoter (catalyst): Phosphoric acid, manufactured by Tokyo Chemical Industry Co., Ltd.
Solvent: Propylene glycol monomethyl ether acetate, manufactured by Tokyo Chemical Industry Co., Ltd.

What is claimed is:

1. A flexographic printing plate precursor for laser engraving comprising:
a relief-forming layer formed from a resin composition for laser engraving,
wherein the flexographic printing plate precursor for laser engraving has matting agent particles at the surface of the relief-forming layer, and the matting agent particles comprise a water-soluble resin and have a number average particle size of 2 μm to 40 μm.

2. The flexographic printing plate precursor for laser engraving according to claim 1, wherein the water-soluble resin is a copolymer containing a monomer unit having an acidic group.

3. The flexographic printing plate precursor for laser engraving according to claim 1, wherein the water-soluble resin is a copolymer containing (a) a monomer unit derived from at least one monomer selected from the group consisting of alkyl acrylates with an alkyl residue having 2 to 10 carbon atoms and alkyl methacrylates with an alkyl residue having 4 to 10 carbon atoms.

4. The flexographic printing plate precursor for laser engraving according to claim 2, wherein the water-soluble resin is a copolymer containing (a) a monomer unit derived from at least one monomer selected from the group consisting of alkyl acrylates with an alkyl residue having 2 to 10 carbon atoms and alkyl methacrylates with an alkyl residue having 4 to 10 carbon atoms.

5. The flexographic printing plate precursor for laser engraving according to claim 1, wherein the water-soluble resin is a copolymer containing (b) a monomer unit derived from at least one monomer selected from the group consisting of a styrene compound, an acrylonitrile compound, methyl methacrylate and ethyl methacrylate.

6. The flexographic printing plate precursor for laser engraving according to claim 2, wherein the water-soluble resin is a copolymer containing (b) a monomer unit derived from at least one monomer selected from the group consisting of a styrene compound, an acrylonitrile compound, methyl methacrylate and ethyl methacrylate.

7. The flexographic printing plate precursor for laser engraving according to claim 4, wherein the water-soluble resin is a copolymer containing (b) a monomer unit derived from at least one monomer selected from the group consisting of a styrene compound, an acrylonitrile compound, methyl methacrylate and ethyl methacrylate.

8. The flexographic printing plate precursor for laser engraving according to claim 2, wherein the copolymer containing a monomer unit having an acidic group is a copolymer containing (c) a monomer unit derived from at least one monomer selected from the group consisting of acrylic acid, methacrylic acid, maleic acid, itaconic acid, and alkali metal salts and ammonium salts of these acids.

9. The flexographic printing plate precursor for laser engraving according to claim 4, wherein the copolymer containing a monomer unit having an acidic group is a copolymer containing (c) a monomer unit derived from at least one monomer selected from the group consisting of acrylic acid, methacrylic acid, maleic acid, itaconic acid, and alkali metal salts and ammonium salts of these acids.

10. The flexographic printing plate precursor for laser engraving according to claim 6, wherein the copolymer containing a monomer unit having an acidic group is a copolymer containing (c) a monomer unit derived from at least one monomer selected from the group consisting of acrylic acid, methacrylic acid, maleic acid, itaconic acid, and alkali metal salts and ammonium salts of these acids.

11. The flexographic printing plate precursor for laser engraving according to claim 1, wherein the water-soluble resin is a resin comprising 10 mass % to 70 mass % of the (a) monomer unit derived from at least one monomer selected from the group consisting of alkyl acrylates with an alkyl residue having 2 to 10 carbon atoms and alkyl methacrylates with an alkyl residue having 4 to 10 carbon atoms; 20 mass % to 80 mass % of the (b) monomer unit derived from at least one monomer selected from the group consisting of a styrene compound, an acrylonitrile compound, methyl methacrylate and ethyl methacrylate; and 6 mass % to 50 mass % of the (c) monomer unit derived from at least one monomer selected from the group consisting of acrylic acid, methacrylic acid, maleic acid, itaconic acid, and alkali metal salts and ammonium salts of these acids.

12. The flexographic printing plate precursor for laser engraving according to claim 1, wherein the resin composition for laser engraving further comprises a polyurethane resin.

13. The flexographic printing plate precursor for laser engraving according to claim 1, wherein the resin composition for laser engraving further comprises a filler.

14. The flexographic printing plate precursor for laser engraving according to claim 13, wherein the filler in the resin composition for laser engraving is carbon black.

15. The flexographic printing plate precursor for laser engraving according to claim 1, wherein the flexographic printing plate precursor for laser engraving have a crosslinked relief-forming layer which is produced by thermally crosslinking a relief-forming layer comprising the resin composition for laser engraving.

16. A process for producing the flexographic printing plate precursor for laser engraving according to claim 1, the process comprising:
a layer forming step of forming a relief-forming layer comprising a resin composition for laser engraving;
a crosslinking step of thermally crosslinking the relief-forming layer to obtain a crosslinked relief-forming layer; and
a matting agent forming step of forming the matting agent particles at the surface of the relief-forming layer or the crosslinked relief-forming layer.

17. A process for making a flexographic printing plate, the process comprising:
an engraving step of laser-engraving the crosslinked relief-forming layer of the flexographic printing plate precursor for laser engraving according to claim 15 to form a relief layer.

18. The process for making a flexographic printing plate according to claim 17, wherein the process further comprises a rinsing step of rinsing the surface of the relief layer with water or a liquid containing water as a main component, after the engraving step.

19. A flexographic printing plate made by the process for making a flexographic printing plate according to claim 17.
